(19) United States
(12) Patent Application Publication
(10) Pub. No.: US 2018/0163132 A1
(43) Pub. Date: Jun. 14, 2018

(54) LIQUID CRYSTAL COMPOSITION AND LIQUID CRYSTAL DISPLAY DEVICE

(71) Applicants: JNC CORPORATION, Tokyo (JP); JNC PETROCHEMICAL CORPORATION, Tokyo (JP)

(72) Inventors: Hiroshi ENDO, Chiba (JP); Masayuki Saito, Chiba (JP)

(73) Assignees: JNC CORPORATION, TOKYO (JP); JNC PETROCHEMICAL CORPORATION, TOKYO (JP)

(21) Appl. No.: 15/829,992

(22) Filed: Dec. 4, 2017

(30) Foreign Application Priority Data
Dec. 8, 2016 (JP) 2016-238307

(51) Int. Cl. C09K 19/34; C09K 19/30; C09K 19/54; G02F 1/1337

(52) U.S. Cl. CPC C09K 19/3402; G02F 1/1368; C09K 19/3003; C09K 19/3068; C09K 19/3098; C09K 19/542; G02F 1/133711; C09K 2019/548; C09K 2019/3425; C09K 2019/3004; C09K 2019/3009; C09K 2019/301; C09K 2019/3016; C09K 2019/3071; C09K 2019/3021; C09K 19/3066

(57) ABSTRACT

Provided are a liquid crystal composition satisfying at least one of characteristics such as a high maximum temperature, a low minimum temperature, small viscosity, suitable optical anisotropy and large dielectric anisotropy, or having a suitable balance regarding at least two characteristics, and an AM device containing the composition.

The liquid crystal composition contains a specific compound having small viscosity as a first component, and may contain a specific compound having negative dielectric constant as a second component, a specific compound having a high maximum temperature or small viscosity as a third component, or a specific compound having a polymerizable group as an additive.

### CROSS-REFERENCE TO RELATED APPLICATIONS

This application claims the priority benefit of Japanese application serial no. 2016-238307,filed on Dec. 08, 2016. The entirety of the above-mentioned patent application is hereby incorporated by reference herein and made a part of this specification.

### TECHNICAL FIELD

The invention relates to a liquid crystal composition, a liquid crystal display device including the composition, and so forth. In particular, the invention relates to a liquid crystal composition having negative dielectric anisotropy, and a liquid crystal display device that includes the composition and has a mode such as an IPS mode, a VA mode, an FFS mode and an FPA mode. The invention also relates to a liquid crystal display device having a polymer sustained alignment mode.

### BACKGROUND ART

In a liquid crystal display device, a classification based on an operating mode for liquid crystal molecules includes a phase change (PC) mode, a twisted nematic (TN) mode, a super twisted nematic (STN) mode, an electrically controlled birefringence (ECB) mode, an optically compensated bend (OCB) mode, an in-plane switching (IPS) mode, a vertical alignment (VA) mode, a fringe field switching (FFS) mode and a field-induced photo-reactive alignment (FPA) mode. A classification based on a driving mode in the device includes a passive matrix (PM) and an active matrix (AM). The PM is classified into static, multiplex and so forth, and the AM is classified into a thin film transistor (TFT), a metal insulator metal (MIM) and so forth. The TFT is further classified into amorphous silicon and polycrystal silicon. The latter is classified into a high temperature type and a low temperature type based on a production process. A classification based on a light source includes a reflective type utilizing natural light, a transmissive type utilizing backlight and a transflective type utilizing both the natural light and the backlight.

The liquid crystal display device includes a liquid crystal composition having a nematic phase. The composition has suitable characteristics. An AM device having good characteristics can be obtained by improving characteristics of the composition. Table 1 below summarizes a relationship in the characteristics. The characteristics of the composition will be further described based on a commercially available AM device. A temperature range of the nematic phase relates to a temperature range in which the device can be used. A preferred maximum temperature of the nematic phase is about 70° C. or higher, and a preferred minimum temperature of the nematic phase is about −10° C. or lower. Viscosity of the composition relates to a response time in the device. A short response time is preferred for displaying moving images on the device. A shorter response time even by one millisecond is desirable. Accordingly, small viscosity in the composition is preferred. Small viscosity at a low temperature is further preferred.

TABLE 1
Characteristics of Composition and AM Device

| No. | Characteristics of Composition | Characteristics of AM Device |
|---|---|---|
| 1 | Wide temperature range of a | Wide usable temperature range |
| | nematic phase | |
| 2 | Small viscosity | Short response time |
| 3 | Suitable optical anisotropy | Large contrast ratio |
| 4 | Large positive or negative | Low threshold voltage, small |
| | dielectric anisotropy | electric power consumption and |
| | | large contrast ratio |
| 5 | Large specific resistance | Large voltage holding ratio and |
| | | large contrast ratio |
| 6 | High stability to ultraviolet light | Long service life |
| | and heat | |

Optical anisotropy of the composition relates to a contrast ratio in the device. According to a mode of the device, large optical anisotropy or small optical anisotropy, more specifically, suitable optical anisotropy is required. A product (Δn×d) of the optical anisotropy (Δn) of the composition and a cell gap (d) in the device is designed so as to maximize the contrast ratio. A suitable value of the product depends on a type of the operating mode. The suitable value is in the range of about 0.30 micrometer to about 0.40 micrometer in a device having the VA mode, and is in the range of about 0.20 micrometer to about 0.30 micrometer in a device having the IPS mode or the FFS mode. In the above case, a composition having the large optical anisotropy is preferred for a device having a small cell gap. Large dielectric anisotropy in the composition contributes to a low threshold voltage, a small electric power consumption and a large contrast ratio in the device. Accordingly, the large dielectric anisotropy is preferred. Large specific resistance in the composition contributes to a large voltage holding ratio and the large contrast ratio in the device. Accordingly, a composition having the large specific resistance in an initial stage is preferred. The composition having the large specific resistance after the device has been used for a long period of time is preferred. Stability of the composition to ultraviolet light and heat relates to a service life of the device. In the case where the stability is high, the device has a long service life. Such characteristics are preferred for an AM device used in a liquid crystal projector, a liquid crystal television and so forth.

Vertical alignment of liquid crystal molecules is achieved by a specific polyimide-alignment film in a general-purpose liquid crystal display device. In a liquid crystal display device having a polymer sustained alignment (PSA) mode, the alignment film is combined with a polymer. First, a composition to which a small amount of a polymerizable compound is added is injected into the device. Then, the composition is irradiated with ultraviolet light while voltage is applied between substrates of the device. The polymerizable compound is polymerized to form a network structure of the polymer in the composition. In the composition, alignment of liquid crystal molecules can be controlled by the polymer, and therefore the response time of the device is shortened and also image persistence is improved. Such an effect of the polymer can be expected for a device having the mode such as the TN mode, the ECB mode, the OCB mode, the IPS mode, the VA mode, the FFS mode and the FPA mode.

A composition having positive dielectric anisotropy is used in an AM device having the TN mode. A composition having negative dielectric anisotropy is used in an AM device having the VA mode. A composition having the positive or negative dielectric anisotropy is used in an AM device having the IPS mode or the FFS mode. A composition having the positive or negative dielectric anisotropy is used in an AM device having the polymer sustained alignment (PSA) mode. An example of a first component of the invention is disclosed in Patent literature No. 1 described below.

### CITATION LIST

### Patent Literature

Patent literature No. 1: US 2001-9272 A

### SUMMARY OF INVENTION

The invention provides a liquid crystal composition satisfying at least one of characteristics such as a high maximum temperature of a nematic phase, a low minimum temperature of the nematic phase, small viscosity, suitable optical anisotropy, large negative dielectric anisotropy, large specific resistance, high stability to ultraviolet light and high stability to heat. The invention further provides the liquid crystal composition having a suitable balance regarding at least two characteristics. The invention further provides a liquid crystal display device including such a composition. The invention further provides an AM device having characteristics such as a short response time, a large voltage holding ratio, a low threshold voltage, a large contrast ratio and a long service life.

The invention concerns a liquid crystal composition containing at least one compound selected from the group of compounds represented by formula (1) as a first component, and having a nematic phase and negative dielectric anisotropy, and a liquid crystal display device including the composition:

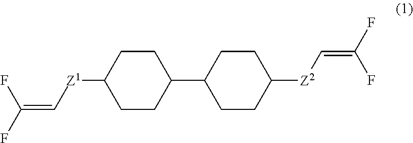

wherein, in formula (1), Z¹ and Z² are independently a single bond or alkylene having 1 to 10 carbons, and in the alkylene, at least one piece of —CH₂— may be replaced by —O—, —CO—, —COO— or —OCO—.

### DESCRIPTION OF EMBODIMENTS

The invention provides a liquid crystal composition satisfying at least one of characteristics such as a high maximum temperature of a nematic phase, a low minimum temperature of the nematic phase, small viscosity, suitable optical anisotropy, large negative dielectric anisotropy, large specific resistance, high stability to ultraviolet light and high stability to heat. The invention further provides the liquid crystal composition having a suitable balance regarding at least two characteristics. The invention further provides a liquid crystal display device including such a composition. The invention further provides an AM device having characteristics such as a short response time, a large voltage holding ratio, a low threshold voltage, a large contrast ratio and a long service life.

Usage of terms herein is as described below. Terms “liquid crystal composition” and “liquid crystal display device” may be occasionally abbreviated as “composition” and “device,” respectively. “Liquid crystal display device” is a generic term for a liquid crystal display panel and a liquid crystal display module. “Liquid crystal compound” is a generic term for a compound having a liquid crystal phase such as a nematic phase and a smectic phase, and a compound having no liquid crystal phase but being mixed with the composition for the purpose of adjusting characteristics such as a temperature range of the nematic phase, viscosity and dielectric anisotropy. The compound has a six-membered ring such as 1,4-cyclohexylene and 1,4-phenylene, and has rod-like molecular structure. “Polymerizable compound” includes a compound to be added to the composition for the purpose of forming a polymer in the composition. A liquid crystal compound having alkenyl is not polymerizable in the above meaning.

The liquid crystal composition is prepared by mixing a plurality of liquid crystal compounds. An additive such as an optically active compound, an antioxidant, an ultraviolet light absorber, a dye, an antifoaming agent, the polymerizable compound, a polymerization initiator, a polymerization inhibitor and a polar compound is added when necessary. A proportion of the liquid crystal compound is expressed in terms of weight percent (% by weight) based on the weight of the liquid crystal composition containing no additive, even after the additive has been added. A proportion of the additive is expressed in terms of weight percent (% by weight) based on the weight of the liquid crystal composition containing no additive. More specifically, a proportion of the liquid crystal compound and the additive is calculated based on the total weight of the liquid crystal compound. Weight parts per million (ppm) may be occasionally used. A proportion of the polymerization initiator and the polymerization inhibitor is exceptionally expressed based on the weight of the polymerizable compound.

“Maximum temperature of the nematic phase” may be occasionally abbreviated as “maximum temperature.” “Minimum temperature of the nematic phase” may be occasionally abbreviated as “minimum temperature.” An expression “having large specific resistance” means that the composition has large specific resistance in an initial stage, and the composition has the large specific resistance even after the device has been used for a long period of time. An expression “having a large voltage holding ratio” means that the device has a large voltage holding ratio at room temperature and also at a temperature close to the maximum temperature in the initial stage, and the device has the large voltage holding ratio at room temperature and also at a temperature close to the maximum temperature even after the device has been used for the long period of time. The characteristics of the composition and the device may be occasionally examined before and after an aging test (including an acceleration deterioration test). An expression “increase the dielectric anisotropy” means that a value of dielectric anisotropy positively increases in a liquid crystal composition having positive dielectric anisotropy, and the value of dielectric anisotropy negatively increases in a liquid crystal composition having negative dielectric anisotropy.

A compound represented by formula (1) may be occasionally abbreviated as “compound (1).” At least one compound selected from the group of compounds represented by formula (2) may be occasionally abbreviated as “compound (2).” “Compound (1)” means one compound, a mixture of two compounds or a mixture of three or more compounds represented by formula (1). A same rule applies also to any other compound represented by any other formulas. An expression “at least one piece of ‘A’” means that the number of ‘A’ is arbitrary. An expression “at least one piece of ‘A’ may be replaced by ‘B’” means that, when the number of ‘A’ is 1, a position of ‘A’ is arbitrary, and also when the number of ‘A’ is 2 or more, positions thereof can be selected without limitation. A same rule applies also to an expression “at least one piece of ‘A’ is replaced by ‘B’.”

An expression “at least one piece of —CH₂— may be replaced by —O—” is used herein. In the above case, pieces of —CH₂— that are not adjacent to each other may be replaced by —O— to convert —CH₂—CH₂—CH₂— into —O—CH₂—O—. However, pieces of —CH₂— that are adjacent to each other never be replaced by —O—. The reason is that —O—O—CH₂— (peroxide) is formed in the replacement. More specifically, the above expression means both “one piece of —CH₂— may be replaced by —O—” and “at least two pieces of —CH₂— that are not adjacent to each other may be replaced by —O—.” A same rule applies to replacement to —O—, and also to replacement to a divalent group such as —CH═CH— or —COO—.

A symbol of terminal group R¹ is used for a plurality of compounds in chemical formulas of component compounds. In the compounds, two of groups represented by any two pieces of R¹ may be identical or different. In one case, for example, R¹ of compound (2-1) is ethyl and R¹ of compound (2-2) is ethyl. In another case, R¹ of compound (2-1) is ethyl and R¹ of compound (2-2) is propyl. A same rule applies also to a symbol such as any other terminal groups. In formula (2), when a subscript ‘a’ is 2, two of rings A exist. In the compound, two of rings represented by two of rings A may be identical or different. A same rule applies also to any two of rings A when the subscript ‘a’ is larger than 2. A same rule applies also to symbols such as Z¹ and ring D. A same rule applies also to such a case where two pieces of −Sp²-P⁵ exist in compound (4-27).

Symbols such as A, B, C and D surrounded by a hexagonal shape correspond to rings such as ring A, ring B, ring C and ring D, respectively, and represent rings such as a six-membered ring and a condensed ring. In compound (4), an oblique line crossing the hexagonal shape represents that arbitrary hydrogen on the ring can be replaced by a group such as -Sp¹-P¹. A subscript such as ‘e’ represents the number of groups replaced. When the subscript ‘e’ is 0, no such replacement exists. When ‘e’ is 2 or more, a plurality of pieces of -Sp¹-P¹ exist on ring F. The plurality of groups represented by -Sp¹-P¹ may be identical or different. In an expression “ring A and ring B are independently X, Y or Z,” a subject is plural, and therefore a term “independently” is used. When the subject is “ring A,” the subject is singular, and therefore the term “independently” is not used.

Then, 2-fluoro-1,4-phenylene means two divalent groups described below. In a chemical formula thereof, fluorine may be leftward (L) or rightward (R). A same rule applies also to an asymmetrical divalent group formed by removing two hydrogen from a ring, such as tetrahydropyran-2,5-diyl. A same rule applies also to a divalent bonding group such as carbonyloxy (—COO or —OCO—).

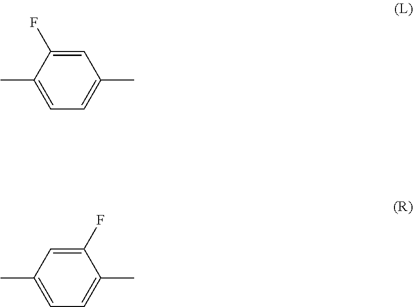

Alkyl of the liquid crystal composition is straight-chain alkyl or branched-chain alkyl, and includes no cyclic alkyl. Straight-chain alkyl is preferred to branched-chain alkyl. A same rule applies also to a terminal group such as alkoxy and alkenyl. With regard to a configuration of 1,4-cyclohexylene, trans is preferred to cis for increasing the maximum temperature.

The invention includes items described below.

Item 1. A liquid crystal composition containing at least one compound selected from the group of compounds represented by formula (1) as a first component, and having a nematic phase and negative dielectric anisotropy:

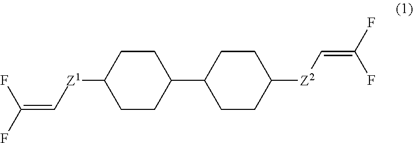

wherein, in formula (1), Z¹ and Z² are independently a single bond or alkylene having 1 to 10 carbons, and in the alkylene, at least one piece of —CH₂— may be replaced by —O—, —CO—, —COO— or —OCO—.

Item 2. The liquid crystal composition according to item 1, wherein a composition of the first component is in the range of 3% by weight to 50% by weight.

Item 3. The liquid crystal composition according to item 1 or 2, containing at least one compound selected from the group of compounds represented by formula (2) as a second component:

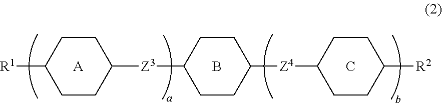

wherein, in formula (2), R¹ and R² are independently alkyl having 1 to 12 carbons, alkoxy having 1 to 12 carbons, alkenyl having 2 to 12 carbons, or alkyl having 1 to 12 carbons in which at least one hydrogen is replaced by fluorine or chlorine; ring A and ring C are independently 1,4-cyclohexylene, 1,4-cyclohexenylene, tetrahydropyran-2,5-diyl, 1,4-phenylene, 1,4-phenylene in which at least one hydrogen is replaced by fluorine or chlorine, chroman-2,6-diyl, or chroman-2,6-diyl in which at least one hydrogen is replaced by fluorine or chlorine; ring B is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 7,8-difluorochroman-2,6-diyl; Z³ and Z⁴ are independently a single bond, ethylene, carbonyloxy or methyleneoxy; a is 1, 2 or 3; b is 0 or 1; and a sum of a and b is 3 or less.

Item 4. The liquid crystal composition according to anyone of items 1 to 3, containing at least one compound selected from the group of compounds represented by formula (2-1) to formula (2-22) as the second component:

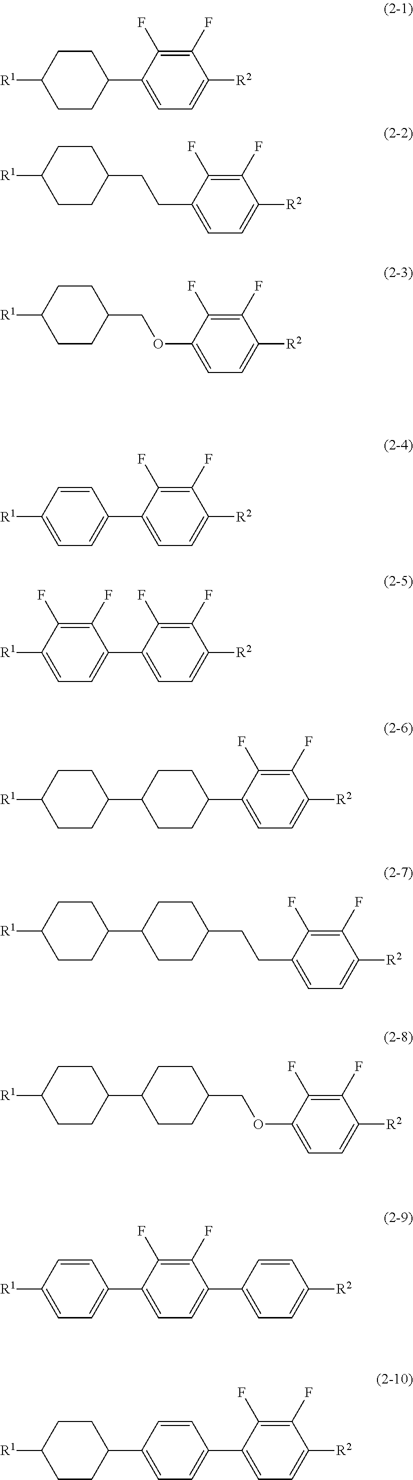

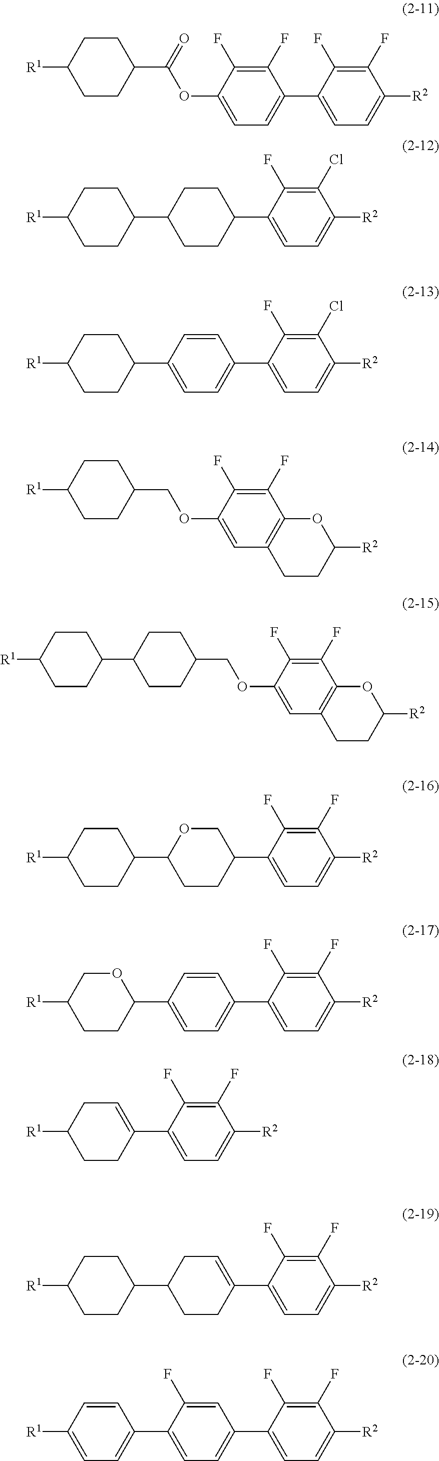

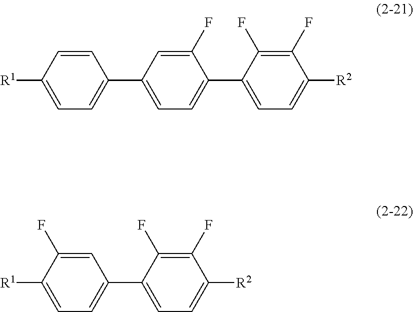

wherein, in formula (2-1) to formula (2-22), R¹ and R² are independently alkyl having 1 to 12 carbons, alkoxy having 1 to 12 carbons, alkenyl having 2 to 12 carbons, or alkyl having 1 to 12 carbons in which at least one hydrogen is replaced by fluorine or chlorine.

Item 5. The liquid crystal composition according to item 3 or 4, wherein a proportion of the second component is in the range of 15% by weight to 70% by weight.

Item 6. The liquid crystal composition according to any one of items 1 to 5, containing at least one compound selected from the group of compounds represented by formula (3) as a third component:

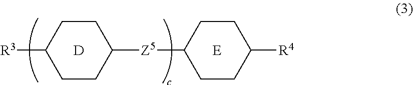

wherein, in formula (3), R³ and R⁴ are independently alkyl having 1 to 12 carbons, alkoxy having 1 to 12 carbons, alkenyl having 2 to 12 carbons, or alkyl having 1 to 12 carbons in which at least one hydrogen is replaced by fluorine or chlorine; ring D and ring E are independently 1,4-cyclohexylene, 1,4-phenylene, 2-fluoro-1,4-phenylene or 2,5-difluoro-1,4-phenylene; Z⁵ is a single bond, ethylene or carbonyloxy; and c is 1, 2 or 3.

Item 7. The liquid crystal composition according to any one of items 1 to 6, containing at least one compound selected from the group of compounds represented by formula (3-1) to formula (3-13) as the third component:

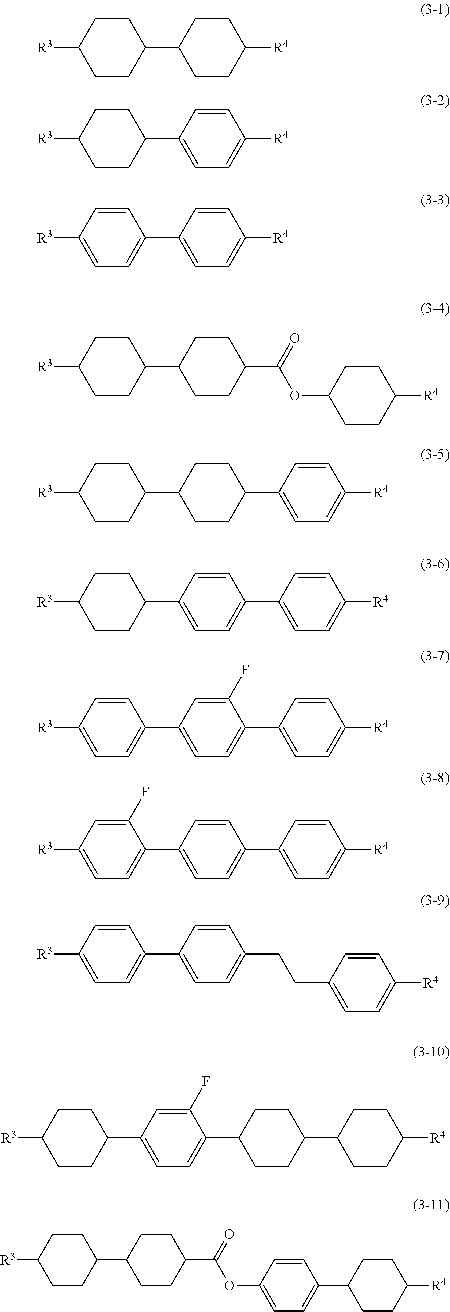

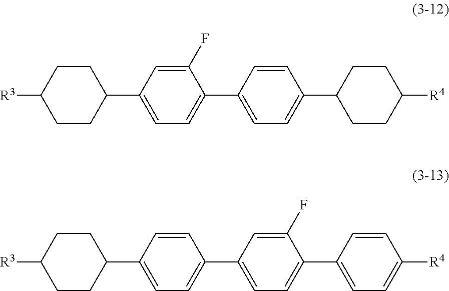

wherein, in formula (3-1) to formula (3-13), R³ and R⁴ are independently alkyl having 1 to 12 carbons, alkoxy having 1 to 12 carbons, alkenyl having 2 to 12 carbons, or alkyl having 1 to 12 carbons in which at least one hydrogen is replaced by fluorine or chlorine.

Item 8. The liquid crystal composition according to item 6 or 7, wherein a proportion of the third component is in the range of 10% by weight to 80% by weight.

Item 9. The liquid crystal composition according to any one of items 1 to 8, containing at least one compound selected from the group of compounds represented by formula (4) as an additive:

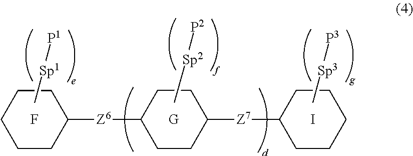

wherein, in formula (4), ring F and ring I are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen is replaced by fluorine or chlorine; ring G is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen may be replaced by fluorine or chlorine; Z⁶ and Z⁷ are independently a single bond or alkylene having 1 to 10 carbons, and in the alkylene, at least one piece of —CH₂— may be replaced by —O—, —CO—, —COO—, or —OCO—, and at least one piece of —CH₂—CH₂— may be replaced by —CH═CH—, —C(CH₃)═CH—, —CH═C(CH₃)— or —C(CH₃)═C(CH₃) —, and in the groups, at least one hydrogen may be replaced by fluorine or chlorine; P¹, P² and P³ are independently a polymerizable group; Sp¹, Sp² and Sp³ are independently a single bond or alkylene having 1 to 10 carbons, and in the alkylene, at least one piece of —CH₂— may be replaced by —O—, —COO—, —OCO— or —OCOO—, and at least one piece of —CH₂—CH₂— may be replaced by —CH═CH— or —C≡C—, and in the groups, at least one hydrogen may be replaced by fluorine or chlorine; d is 0, 1 or 2; e, f and g are independently 0, 1, 2, 3 or 4; and a sum of e, f and g is 1 or more.

Item 10. The liquid crystal composition according to item 9, wherein, in formula (4), P¹, P² and P³ are independently a group selected from the group of polymerizable groups represented by formula (P-1) to formula (P-5) :

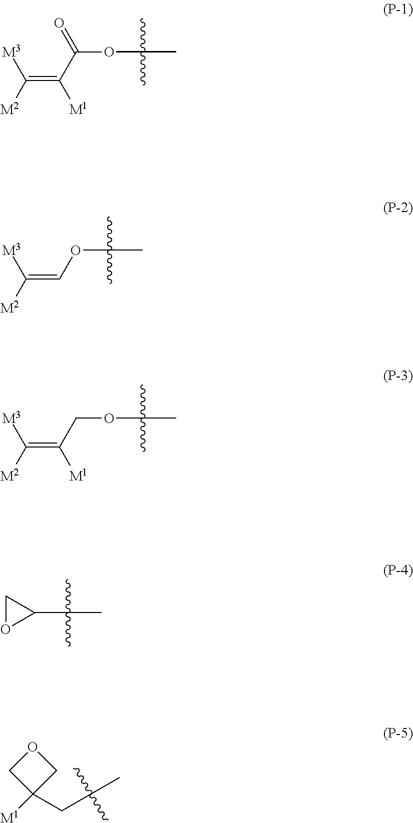

wherein, in formula (P-1) to formula (P-5), M¹, M² and M³ are independently hydrogen, fluorine, alkyl having 1 to 5 carbons, or alkyl having 1 to 5 carbons in which at least one hydrogen is replaced by fluorine or chlorine.

Item 11. The liquid crystal composition according to any one of items 1 to 10, containing at least one compound selected from the group of polymerizable compounds represented by formula (4-1) to formula (4-27) as the additive:

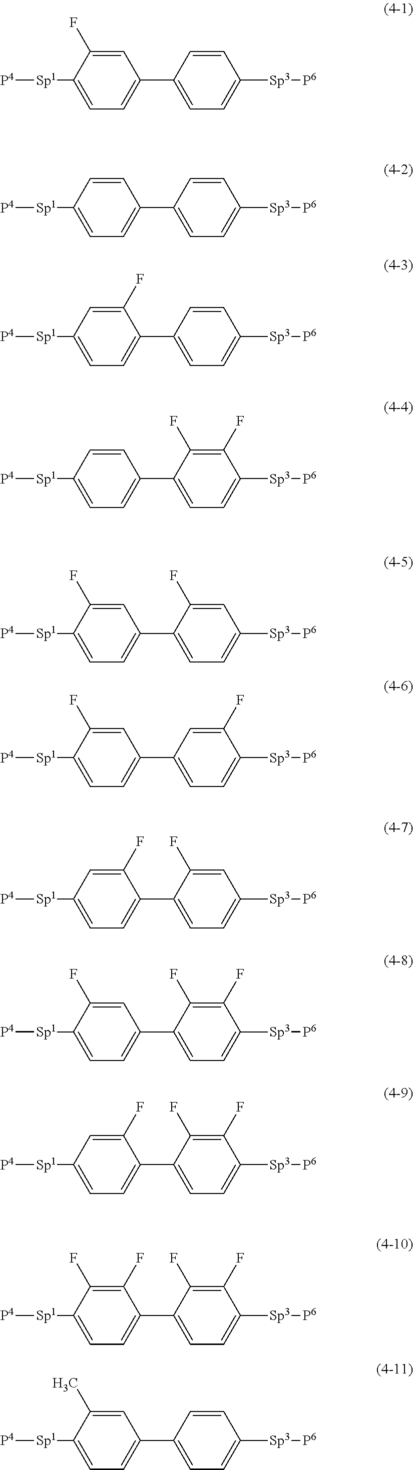

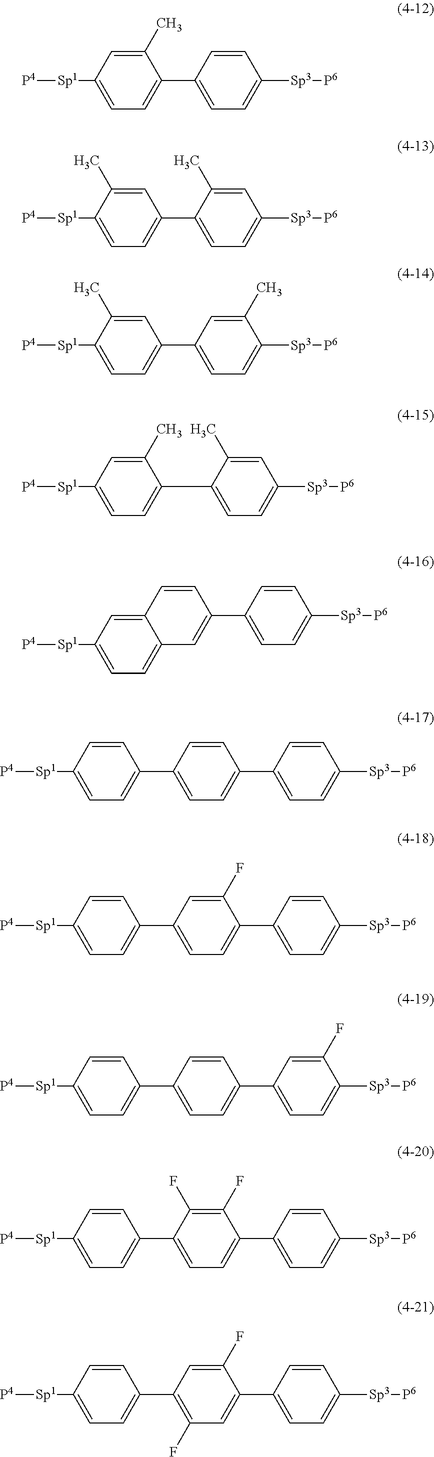

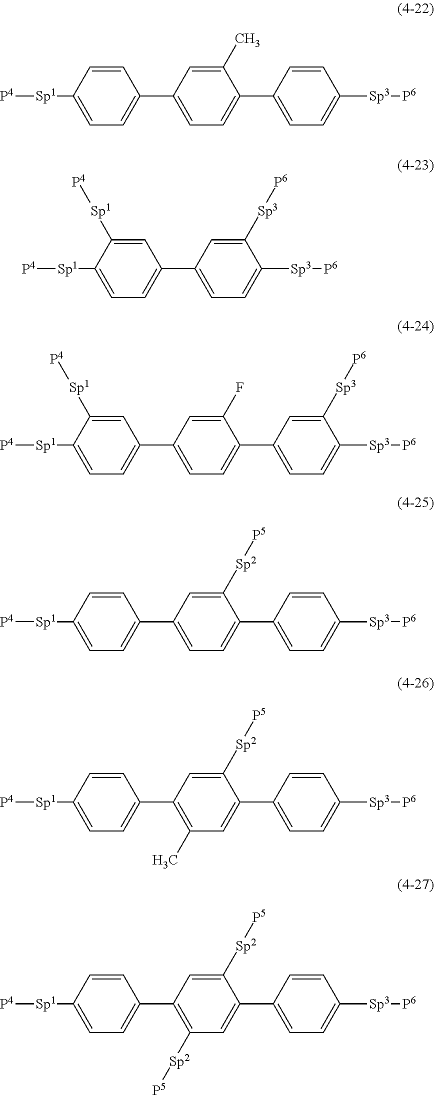

wherein, in formula (4-1) to formula (4-27), P⁴, P⁵ and P⁶ are independently a group selected from the group of polymerizable groups represented by formula (P-1) to formula (P-3):

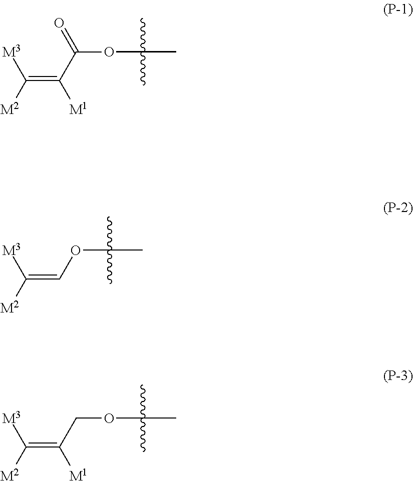

wherein, M¹, M² and M³ are independently hydrogen, fluorine, alkyl having 1 to 5 carbons, or alkyl having 1 to 5 carbons in which at least one hydrogen is replaced by fluorine or chlorine; Sp¹, Sp² and Sp³ are independently a single bond or alkylene having 1 to 10 carbons, and in the alkylene, at least one piece of —CH₂— may be replaced by —O—, —COO—, —OCO— or —OCOO—, and at least one piece of —CH₂—CH₂— may be replaced by —CH═CH— or —C≡C—, and in the groups, at least one hydrogen may be replaced by fluorine or chlorine.

Item 12. The liquid crystal composition according to any one of items 9 to 11, wherein a proportion of the additive is in the range of 0.03%, by weight to 10% by weight.

Item 13. A liquid crystal display device including the liquid crystal composition according to any one of items 1 to 12.

Item 14. The liquid crystal display device according to item 13, wherein an operating mode in the liquid crystal display device includes an IPS mode, a VA mode, an FFS mode or an FPA mode, and a driving mode in the liquid crystal display device includes an active matrix mode.

Item 15. A polymer sustained alignment mode liquid crystal display device, wherein the liquid crystal display device includes the liquid crystal composition according to any one of items 1 to 11, and the additive contained in the liquid crystal composition is polymerized.

Item 16. Use of the liquid crystal composition according to any one of items 1 to 11 in a liquid crystal display device.

Item 17. Use of the liquid crystal composition according to any one of items 1 to 11 in a polymer sustained alignment mode liquid crystal display device.

The invention further includes the following items: (a) the composition, further containing at least one additive such as an optically active compound, an antioxidant, an ultraviolet light absorber, a dye, an antifoaming agent, a polymerizable compound, a polymerization initiator, a polymerization inhibitor and a polar compound; (b) an AM device including the composition; (c) a polymer sustained alignment (PSA) mode AM device including the composition, further containing a polymerizable compound; (d) a polymer sustained alignment (PSA) mode AM device including the composition in which the polymerizable compound in the composition is polymerized; (e) a device including the composition and having the PC mode, the TN mode, the STN mode, the ECB mode, the OCB mode, the IPS mode, the VA mode, the FFS mode or the FPA mode; (f) a transmissive device including the composition; (g) use of the composition as the composition having the nematic phase; and (h) use as an optically active composition by adding the optically active compound to the composition.

The composition of the invention will be described in the following order. First, a constitution of the composition will be described. Second, main characteristics of the component compounds and main effects of the compounds on the composition will be described. Third, a combination of components in the composition, a preferred proportion of the components and the basis thereof will be described. Fourth, a preferred embodiment of the component compounds will be described. Fifth, a preferred component compounds will be described. Sixth, an additive that may be added to the composition will be described. Seventh, methods for synthesizing the component compounds will be described. Last, an application of the composition will be described.

First, the constitution of the composition will be described. The composition of the invention is classified into composition A and composition B. Composition A may further contain any other liquid crystal compound, additive or the like in addition to the liquid crystal compound selected from compound (1), compound (2) and compound (3). “Any other liquid crystal compound” means a liquid crystal compound different from compound (1), compound (2) and compound (3). Such a compound is mixed with the composition for the purpose of further adjusting the characteristics. The additive is the optically active compound, the antioxidant, the ultraviolet light absorber, the dye, the antifoaming agent, the polymerizable compound, the polymerization initiator, the polymerization inhibitor, the polar compound or the like.

Composition B consists essentially of the liquid crystal compound selected from compound (1), compound (2) and compound (3). A term “essentially” means that the composition may contain the additive, but contains no any other liquid crystal compound. Composition B has a smaller number of components than composition A has. Composition B is preferred to composition A in view of cost reduction. Composition A is preferred to composition B in view of being able to further adjust the characteristics by mixing any other liquid crystal compound.

Second, the main characteristics of the component compounds and the main effects of the compounds on the composition will be described. The main characteristics of the component compounds are summarized in Table 2 on the basis of advantageous effects of the invention. In Table 2, a symbol L stands for “large” or “high,” a symbol M stands for “medium” and a symbol S stands for “small” or “low.” The symbols L, M and S represent a classification based on a qualitative comparison among the component compounds, and 0 (zero) means that a value is zero or close to zero.

TABLE 2
Characteristics of Compounds

| Characteristics | Compound (1) | Compound (2) | Compound (3) |
|---|---|---|---|
| Maximum temperature | S to M | S to L | S to L |
| Viscosity | S | M to L | S to M |
| Optical anisotropy | S | M to L | S to L |
| Dielectric anisotropy | 0 | M to L¹⁾ | 0 |
| Specific resistance | L | L | L |

¹⁾Value of dielectric anisotropy is negative, and the symbol stands for magnitude of an absolute value.

Upon mixing the component compounds with the composition, the main effects of the component compounds on the characteristics of the composition are as described below. Compound (1) decreases the viscosity. Compound (2) increases a dielectric constant and decreases the minimum temperature. Compound (3) increases the maximum temperature or decreases the viscosity. Compound (4) is polymerized to give a polymer, and the polymer shortens a response time in the device, and improves image persistence.

Third, the combination of components in the composition, the preferred proportion of the component compounds and the basis thereof will be described. Preferred combinations of components in the composition include a combination of the first component and the second component, a combination of the first component and the third component, a combination of the first component and the additive, a combination of the first component, the second component and the third component, a combination of the first component, the second component and the additive, a combination of the first component, the third component and the additive and a combination of the first component, the second component, the third component and the additive. Further preferred combinations thereof include a combination of the first component, the second component and the third component or a combination of the first component, the second component, the third component and the additive.

A preferred proportion of the first component is about 3% by weight or more for decreasing the viscosity, and about 50% by weight or less for increasing the dielectric anisotropy. A further preferred proportion is in the range of about 4% by weight to about 30% by weight. A particularly preferred proportion is in the range of about 5% by weight to about 20% by weight.

A preferred proportion of the second component is about 15% by weight or more for increasing the dielectric anisotropy, and about 70% by weight or less for decreasing the minimum temperature. A further preferred proportion is in the range of about 25% by weight to about 65% by weight. A particularly preferred proportion is in the range of about 30% by weight to about 60% by weight.

A preferred proportion of the third component is about 10% by weight or more for increasing the maximum temperature or for decreasing the viscosity, and about 80% by weight or less for increasing the dielectric anisotropy. A further preferred proportion is in the range of about 15% by weight to about 70% by weight. A particularly preferred proportion is in the range of about 20% by weight to about 60% by weight.

The additive is added to the composition for the purpose of adapting the composition to the polymer sustained alignment mode device. A preferred proportion of the additive is about 0.03% by weight or more for aligning the liquid crystal molecules, and about 10% by weight or less for preventing poor display of the device. A further preferred proportion is in the range of about 0.1% by weight to about 2% by weight. A particularly preferred proportion is in the range of about 0.2% by weight to about 1.0% by weight.

Fourth, the preferred embodiment of the component compounds will be described. In formula (1), Z¹ and Z² are independently a single bond or alkylene having 1 to 10 carbons, and in the alkylene, at least one piece of —CH₂— may be replaced by —O—, —CO—, —COO— or —OCO—. Preferred Z¹ or Z² is a single bond for decreasing the viscosity, and ethylene for decreasing the minimum temperature.

In formula (2) and formula (3), R¹ and R² are independently alkyl having 1 to 12 carbons, alkoxy having 1 to 12 carbons, alkenyl having 2 to 12 carbons or alkyl having 1 to 12 carbons in which at least one hydrogen is replaced by fluorine or chlorine. Preferred R¹ or R² is alkyl having 1 to 12 carbons for increasing the stability to ultraviolet light and heat, and alkoxy having 1 to 12 carbons for increasing the dielectric anisotropy. R³ and R⁴ are independently alkyl having 1 to 12 carbons, alkoxy having 1 to 12 carbons, alkenyl having 2 to 12 carbons, or alkyl having 1 to 12 carbons in which at least one hydrogen is replaced by fluorine or chlorine. Preferred R³ or R⁴ is alkenyl having 2 to 12 carbons for decreasing the viscosity, and alkyl having 1 to 12 carbons for increasing the stability to ultraviolet light and heat.

Preferred alkyl is methyl, ethyl, propyl, butyl, pentyl, hexyl, heptyl or octyl. Further preferred alkyl is methyl, ethyl, propyl, butyl or pentyl for decreasing the viscosity.

Preferred alkoxy is methoxy, ethoxy, propoxy, butoxy, pentyloxy, hexyloxy or heptyloxy. Further preferred alkoxy is methoxy or ethoxy for decreasing the viscosity.

Preferred alkenyl is vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl or 5-hexenyl. Further preferred alkenyl is vinyl, 1-propenyl, 3-butenyl or 3-pentenyl for decreasing the viscosity. A preferred configuration of —CH═CH— in the alkenyl depends on a position of a double bond. Trans is preferred in alkenyl such as 1-propenyl, 1-butenyl, 1-pentenyl, 1-hexenyl, 3-pentenyl and 3-hexenyl for decreasing the viscosity, for instance. Cis is preferred in alkenyl such as 2-butenyl, 2-pentenyl and 2-hexenyl.

Preferred examples of alkyl in which at least one hydrogen is replaced by fluorine or chlorine include fluoromethyl, 2-fluoroethyl, 3-fluoropropyl, 4-fluorobutyl, 5-fluoropentyl, 6-fluorohexyl, 7-fluoroheptyl or 8-fluorooctyl. Further preferred examples include 2-fluoroethyl, 3-fluoropropyl, 4-fluorobutyl or 5-fluoropentyl for increasing the dielectric anisotropy.

Preferred examples of alkenyl in which at least one hydrogen is replaced by fluorine or chlorine include 2,2-difluorovinyl, 3,3-difluoro-2-propenyl, 4,4-difluoro-3-butenyl, 5,5-difluoro-4-pentenyl or 6,6-difluoro-5-hexenyl. Further preferred examples include 2,2-difluorovinyl or 4,4-difluoro-3-butenyl for decreasing the viscosity.

Ring A and ring C are independently 1,4-cyclohexylene, 1,4-cyclohexenylene, tetrahydropyran-2,5-diyl, 1,4-phenylene, 1,4-phenylene in which at least one hydrogen is replaced by fluorine or chlorine, chroman-2,6-diyl, or chroman-2,6-diyl in which at least one hydrogen is replaced by fluorine or chlorine. Preferred ring A or ring C is 1,4-cyclohexylene for decreasing the viscosity or for increasing the maximum temperature, and 1,4-phenylene for decreasing the minimum temperature. Tetrahydropyran-2,5-diyl includes:

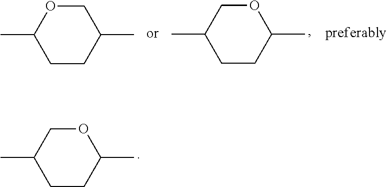

Ring B is 2,3-difluoro-1,4-phenylene, 2-chloro-3-fluoro-1,4-phenylene, 2,3-difluor-5-methyl-1,4-phenylene, 3,4,5-trifluoronaphthalene-2,6-diyl or 7,8-difluorochroman-2,6-diyl. Preferred ring B is 2,3-difluoro-1,4-phenylene for decreasing the viscosity, and 7,8-difluorochroman-2,6-diyl for increasing the dielectric anisotropy.

Ring D and ring E are independently 1,4-cyclohexylene, 1,4-phenylene, 2-fluoro-1,4-phenylene or 2,5-difluoro-1,4-phenylene. Preferred ring D or ring E is 1,4-cyclohexylene for decreasing the viscosity or for increasing the maximum temperature, and 1,4-phenylene for increasing the optical anisotropy.

Z³ and Z⁴ are independently a single bond, ethylene, carbonyloxy or methyleneoxy. Preferred Z³ or Z⁴ is ethylene for decreasing the minimum temperature, and methyleneoxy for increasing the dielectric anisotropy. Z⁵ is a single bond, ethylene or carbonyloxy. Preferred Z⁵ is a single bond for decreasing the viscosity, and carbonyloxy for increasing the maximum temperature.

Then, a is 1, 2 or 3. Preferred a is 1 for decreasing the viscosity, and is 2 or 3 for increasing the maximum temperature. Then, b is 0 or 1, and a sum of a and b is 3 or less. Preferred b is 0 for decreasing the viscosity, and 1 for decreasing the minimum temperature. Then, c is 1, 2 or 3. Preferred c is 1 for decreasing the viscosity, and is 2 or 3 for increasing the maximum temperature.

In formula (4), P¹, P² and P³ are independently a polymerizable group. Preferred P¹, P² or P³ is a group selected from the group of polymerizable groups represented by formula (P-1) to formula (P-5). Further preferred P¹, P² or P³ is a group represented by formula (P-1), formula (P-2) or formula (P-3). Particularly preferred P¹, P² or P³ is a group represented by formula (P-1) or formula (P-2). Most preferred P¹, P² or P³ is —OCO—CH═CH₂ or —OCO—C(CH₃)∇CH₂. A wavy line in formula (P-1) to formula (P-5) represents a site to be bonded.

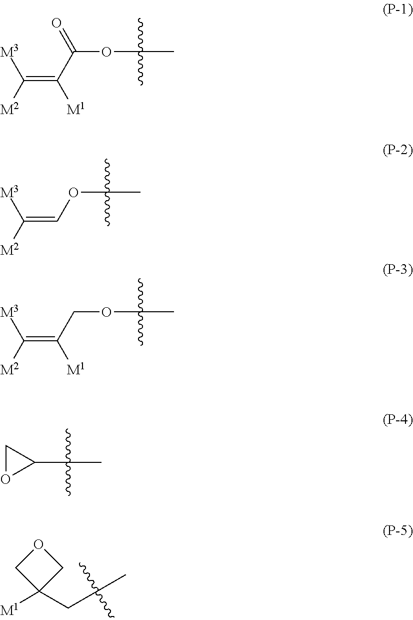

In formula (P-1) to formula (P-5), M¹ , M² ₐₙd M³ are independently hydrogen, fluorine, alkyl having 1 to 5 carbons, or alkyl having 1 to 5 carbons in which at least one hydrogen is replaced by fluorine or chlorine. Preferred M¹, M² or M³ is hydrogen or methyl for increasing reactivity. Further preferred Ml is hydrogen or methyl, and further preferred M² or M³ is hydrogen.

Sp¹, Sp² and Sp³ are independently a single bond or alkylene having 1 to 10 carbons, and in the alkylene, at least one piece of —CH₂— may be replaced by —O—, —COO—, —OCO—, or —OCOO—, and at least one piece of —CH₂—CH₂— may be replaced by —CH═CH— or —C≡C—, and in the groups, at least one hydrogen may be replaced by fluorine or chlorine. Preferred Sp¹, Sp² or Sp³ is a single bond, —CH₂CH₂—, —CH₂O—, —OCH₂—, —COO—, —OCO—, —CO—CH═CH— or —CH═CH—CO—. Further preferred Sp¹, Sp² or Sp³ is a single bond.

Ring F and ring I are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen is replaced by fluorine or chlorine. Preferred ring F or ring I is phenyl. Ring G is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen may be replaced by fluorine or chlorine. Preferred ring G is 1,4-phenylene or 2-fluoro-1,4-phenylene.

Z⁶ and Z⁷ are independently a single bond or alkylene having 1 to 10 carbons, and in the alkylene, at least one piece of —CH₂— may be replaced by —O—, —CO—, —COO— or —OCO—, and at least one piece of —CH₂—CH₂— may be replaced by —CH═CH—, —C(CH₃)═CH—, —CH═C(CH₃)— or —C(CH₃)═C(CH₃)—, and in the groups, at least one hydrogen may be replaced by fluorine or chlorine. Preferred Z⁶ or Z⁷ is a single bond, —CH₂CH₂—, —CH₂O—, —OCH₂—, —COO— or —OCO—. Further preferred Z⁶ or Z⁷ is a single bond.

Then, d is 0, 1 or 2. Preferred d is 0 or 1. Then, e, f, and g are independently 0, 1, 2, 3 or 4, and a sum of e, f and g is 1 or more. Preferred e, f or g is 1 or 2.

Preferred compound (2) includes compound (2-1) to compound (2-22) described in item 4. In the compounds, at least one second component preferably includes compound (2-1), compound (2-2), compound (2-3), compound (2-4), compound (2-6), compound (2-7), compound (2-8) or compound (2-10). At least two second components preferably include a combination of compound (2-1) and compound (2-6), a combination of compound (2-1) and compound (2-10), a combination of compound (2-3) and compound (2-6), a combination of compound (2-3) and compound (2-10), a combination of compound (2-4) and compound (2-6) or a combination of compound (2-4) and compound (2-10). [0070]

Preferred compound (3) includes compound (3-1) to compound (3-13) described in item 7. In the compounds, at least one third component preferably include compound (3-1), compound (3-3), compound (3-5), compound (3-6) or compound (3-7). At least two third components preferably include a combination of compound (3-1) and compound (3-3), (3-3) and compound (3-5) or a combination of compound (3-3) and compound (3-7).

Preferred compound (4) includes compound (4-1) to compound (4-27) described in item 11. In the compounds, at least one additive preferably includes compound (4-1), compound (4-2), compound (4-24), compound (4-25), compound (4-26) or compound (4-27). At least two additives preferably include a combination of compound (4-1) and compound (4-2), a combination of compound (4-1) and compound (4-18), a combination of compound (4-2) and compound (4-24), a combination of compound (4-2) and compound (4-25), a combination of compound (4-2) and compound (4-26), a combination of compound (4-25) and compound (4-26) or a combination of compound (4-18) and compound (4-24).

Sixth, the additive that maybe added to the composition will be described. Such an additive includes the optically active compound, the antioxidant, the ultraviolet light absorber, the dye, the antifoaming agent, the polymerizable compound, the polymerization initiator, the polymerization inhibitor, the polar compound or the like. The optically active compound is added to the composition for the purpose of inducing a helical structure in the liquid crystal molecule to give a twist angle. Examples of such a compound include compound (5-1) to compound (5-5). A preferred proportion of the optically active compound is about 5% by weight or less. A further preferred proportion is in the range of about 0.01% by weight to about 2% by weight.

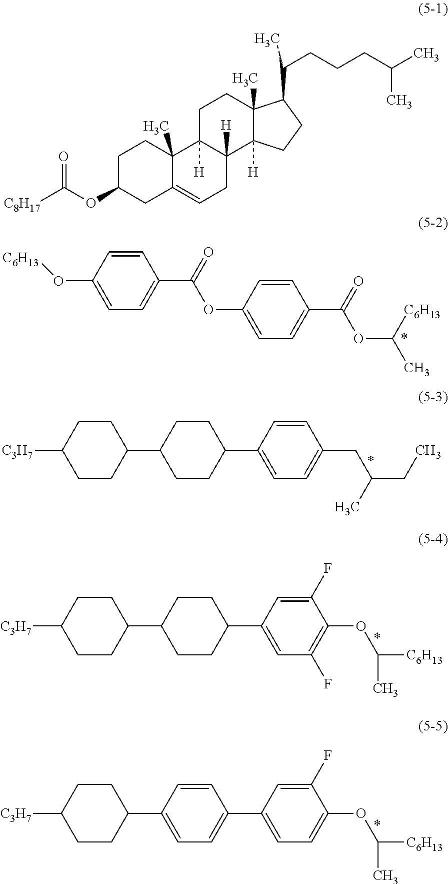

The antioxidant is added to the composition for preventing a decrease in the specific resistance caused by heating in air, or for maintaining a large voltage holding ratio at room temperature and also at the temperature close to the maximum temperature even after the device has been used for a long period of time. Preferred examples of the antioxidant include compound (6) where n is an integer from 1 to 9.

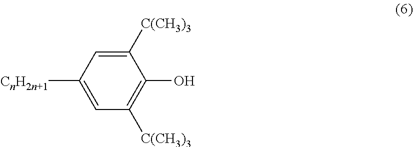

In compound (6), preferred n is 1, 3, 5, 7 or 9. Further preferred n is 7. Compound (6) where n is 7 is effective in maintaining a large voltage holding ratio at room temperature and also at the temperature close to the maximum temperature even after the device has been used for a long period of time because such compound (6) has a small volatility. A preferred proportion of the antioxidant is about 50 ppm or more for achieving an effect thereof, and about 600 ppm or less for avoiding a decrease in the maximum temperature or an increase in the minimum temperature. A further preferred proportion is in the range of about 100 ppm to about 300 ppm.

Preferred examples of the ultraviolet light absorber include a benzophenone derivative, a benzoate derivative and a triazole derivative. A light stabilizer such as an amine having steric hindrance is also preferred. A preferred proportion of the absorber or the stabilizer is about 50 ppm or more for achieving an effect thereof, and about 10,000 ppm or less for avoiding the decrease in the maximum temperature or avoiding the increase in the minimum temperature. A further preferred proportion is in the range of about 100 ppm to about 10,000 ppm.

A dichroic dye such as an azo dye or an anthraquinone dye is added to the composition to be adapted for a device having a guest host (GH) mode. A preferred proportion of the dye is in the range of about 0.01% by weight to about 10% by weight. The antifoaming agent such as dimethyl silicone oil or methyl phenyl silicone oil is added to the composition for preventing foam formation. A preferred proportion of the antifoaming agent is about 1 ppm or more for achieving an effect thereof, and about 1,000 ppm or less for preventing a poor display. A further preferred proportion is in the range of about 1 ppm to about 500 ppm.

The polymerizable compound is used to be adapted for a polymer sustained alignment (PSA) mode device. Compound (4) is suitable for the purpose. A polymerizable compound that is different from compound (4) may be added to the composition together with compound (4). A polymerizable compound that is different from compound (4) maybe added to the composition in place of compound (4). Specific preferred examples of the polymerizable compounds include acrylate, methacrylate, a vinyl compound, a vinyloxy compound, propenyl ether, an epoxy compound (oxirane, oxetane) and vinyl ketone. Further preferred examples include an acrylate derivative or a methacrylate derivative. The reactivity of polymerization and a pretilt angle of a liquid crystal molecule can be adjusted by changing a kind of compound (4), or by combining a polymerizable compound different from compound (5) with compound (5) at a suitable ratio. The short response time of the device can be achieved by optimizing the pretilt angle. The alignment of the liquid crystal molecules is stabilized, and therefore a large contrast ratio and a long service life can be achieved.

The polymerizable compound is polymerized by irradiation with ultraviolet light. The polymerizable compound may be polymerized in the presence of an initiator such as a photopolymerization initiator. Suitable conditions for polymerization, suitable types of the initiator and suitable amounts thereof are known to those skilled in the art and are described in literature. For example, Irgacure 651 (registered trademark; BASF), Irgacure 184 (registered trademark; BASF) or Darocur 1173 (registered trademark; BASF), each being a photoinitiator, is suitable for radical polymerization. A preferred proportion of the photopolymerization initiator is in the range of about 0.1% by weight to about 5⁹6 by weight based on the weight of the polymerizable compound. A further preferred proportion is in the range of about 1% by weight to about 3% by weight based thereon.

Upon storing the polymerizable compound, the polymerization inhibitor may be added thereto for preventing polymerization. The polymerizable compound is ordinarily added to the composition without removing the polymerization inhibitor. Specific examples of the polymerization inhibitor include hydroquinone, a hydroquinone derivative such as methylhydroquinone, 4-tert-butylcatechol, 4-methoxyphenol and phenothiazine.

The polar compound is an organic compound having polarity. Here, a compound having an ionic bond is not included. An atom such as oxygen, sulfur and nitrogen tends to be more electronegative and have a partial negative charge. Carbon and hydrogen tend to be neutral or have a partial positive charge. The polarity is generated caused by uneven distribution of partial charges among different kinds of atoms in a compound. For example, the polar compound has at least one partial structure such as —OH, —COOH, —SH, —NH₂, >NH and >N—.

Seventh, the methods for synthesizing the component compounds will be described. The compounds can be prepared according to known methods. Examples of the synthetic methods are described. A synthetic method of compound (1) is described in a section of Examples. Compound (2-6) is prepared by the method described in JP 2000-053602 A. Compound (3-3) is prepared by the method described in JP S52-53783 A. Compound (4-18) is prepared by the method described in JP H7-101900 A. The antioxidant is commercially available. A compound represented by formula (6) where n is 1 is available from Sigma-Aldrich Corporation. Compound (6) where n is 7, or the like is prepared according to the method described in US 3660505 B.

Any compounds whose synthetic methods are not described can be prepared according to methods described in books such as Organic Syntheses (John Wiley & Sons, Inc.), Organic Reactions (John Wiley & Sons, Inc.), Comprehensive Organic Synthesis (Pergamon Press) and New Experimental Chemistry Course (Shin Jikken Kagaku Koza in Japanese) (Maruzen Co., Ltd.). The composition is prepared according to publicly known methods using the thus obtained compounds. For example, the component compounds are mixed and dissolved in each other by heating.

Last, the application of the composition will be described. The composition mainly has a minimum temperature of about −10° C. or lower, a maximum temperature of about 70° C. or higher, and optical anisotropy in the range of about 0.07 to about 0.20. The composition having optical anisotropy in the range of about 0.08 to about 0.25 may be prepared by controlling the proportion of the component compounds or by mixing any other liquid crystal compound. The composition having the optical anisotropy in the range of about 0.10 to about 0.30 may be prepared by trial and error. A device including the composition has the large voltage holding ratio. The composition is suitable for use in the AM device. The composition is particularly suitable for use in a transmissive AM device. The composition can be used as the composition having the nematic phase, and as the optically active composition by adding the optically active compound.

The composition can be used for the AM device. The composition can also be used for a PM device. The composition can also be used for an AM device and a PM device each having a mode such as the PC mode, the TN mode, the STN mode, the ECB mode, the OCB mode, the IPS mode, the FFS mode, the VA mode and the FPA mode. Use for the AM device having the TN mode, the OCB mode, the IPS mode or the FFS mode is particularly preferred. In the AM device having the IPS mode or the FFS mode, alignment of liquid crystal molecules when no voltage is applied may be parallel or vertical to a glass substrate. The device maybe of a reflective type, a transmissive type or a transflective type. Use for the transmissive device is preferred. The composition can also be used for an amorphous silicon-TFT device or a polycrystal silicon-TFT device. The composition can also be used for a nematic curvilinear aligned phase (NCAP) device prepared by microencapsulating the composition, or for a polymer dispersed (PD) device in which a three-dimensional network-polymer is formed in the composition.

One example of a method for producing the polymer sustained alignment mode device is as described below. A device having two substrates called an array substrate and a color filter substrate is assembled. The substrates have an alignment film. At least one substrate has an electrode layer. The liquid crystal compound is mixed to prepare a liquid crystal composition. The polymerizable compound is added to the composition. The additive may be further added thereto, when necessary. The composition is injected into the device. The device is irradiated with light while voltage is applied to the device. Ultraviolet light is preferred. The polymerizable compound is polymerized by light irradiation. The composition containing the polymer is formed by the polymerization. The polymer sustained alignment mode device is made according to the above procedure.

In the above procedure, when the voltage is applied, liquid crystal molecules are aligned by action of an electric field. The polymerizable compounds are also aligned according to the alignment. The polymerizable compound is polymerized by the ultraviolet light in the above state, and therefore the polymer maintained in the alignment is formed. The response time of the device is shortened by an effect of the polymer. Image persistence is also simultaneously improved by the effect of the polymer since the image persistence is operation failure of the liquid crystal molecules. In addition, the polymerizable compound in the composition is previously polymerized, and the polymerized composition may be arranged between the substrates of the liquid crystal display device.

### EXAMPLES

The invention will be described in greater detail by way of Examples. The invention is not limited by the Examples. The invention includes a mixture of a composition in Example 1 and a composition in Example 2. The invention also includes a mixture prepared by mixing at least two compositions in Examples. A compound prepared was identified by methods such as an NMR analysis. Characteristics of the compound, the composition and a device were measured by methods described below.

NMR analysis: For measurement, DRX-500 made by Bruker BioSpin Corporation was used. In ¹H-NMR measurement, a sample was dissolved in a deuterated solvent such as CDCl₃, and measurement was carried out under conditions of room temperature, 500 MHz and 16 times of accumulation. Tetramethylsilane was used as an internal standard. In ¹⁹F-NMR measurement, CFCl₃ was used as an internal standard, and measurement was carried out under conditions of 24 times of accumulation. In explaining nuclear magnetic resonance spectra obtained, s, d, t, q, quin, sex and m stand for a singlet, a doublet, a triplet, a quartet, a quintet, a sextet and a multiplet, and br being broad, respectively.

Gas chromatographic analysis: For measurement, GC-14B Gas Chromatograph made by Shimadzu Corporation was used. A carrier gas was helium (2 mL/min). A sample vaporizing chamber and a detector (FID) were set to 280° C. and 300° C., respectively. A capillary column DB-1 (length 30 m, bore 0.32 mm, film thickness 0.25 μm; dimethylpolysiloxane as a stationary phase, non-polar) made by Agilent Technologies, Inc. was used for separation of component compounds. After the column was kept at 200° C. for 2 minutes, the column was heated to 280° C. at a rate of 5 ° C. per minute. A sample was prepared in an acetone solution (0.1% by weight), and then 1 microliter of the solution was injected into the sample vaporizing chamber. A recorder was C-R5A Chromatopac made by Shimadzu Corporation or the equivalent thereof. The resulting gas chromatogram showed a retention time of a peak and a peak area corresponding to each of the component compounds.

As a solvent for diluting the sample, chloroform, hexane or the like may also be used. The following capillary columns may also be used for separating component compounds: HP-1 (length 30 m, bore 0.32 mm, film thickness 0.25 μm) made by Agilent Technologies, Inc., Rtx-1 (length 30 m, bore 0.32 mm, film thickness 0.25 μm) made by Restek Corporation and BP-1 (length m, bore 0.32 mm, film thickness 0.25 μm) made by SGE International Pty. Ltd. A capillary column CBP1-M50-025 (length 50 m, bore 0.25 mm, film thickness 0.25 μm) made by Shimadzu Corporation may also be used for the purpose of preventing an overlap of peaks of the compounds.

A proportion of liquid crystal compounds contained in the composition may be calculated by a method as described below. A mixture of liquid crystal compounds is analyzed by gas chromatograph (FID). An area ratio of each peak in the gas chromatogram corresponds to the proportion (weight ratio) of the liquid crystal compound. When the capillary columns described above were used, a correction coefficient of each of the liquid crystal compounds may be regarded as 1. Accordingly, the proportion (% by weight) of the liquid crystal compounds can be calculated from the area ratio of each peak.

Sample for measurement: When characteristics of the composition and the device were measured, the composition was used as was. Upon measuring characteristics of a compound, a sample for measurement was prepared by mixing the compound (15% by weight) with a base liquid crystal (85% by weight). Values of characteristics of the compound were calculated, according to an extrapolation method, using values obtained by measurement: (Extrapolated value) ={(measured value of a sample for measurement)−0.85×(measured value of a base liquid crystal)}/0.15. When a smectic phase (or crystals) precipitates at the ratio thereof at 25° C., a ratio of the compound to the base liquid crystal was changed step by step in the order of (10% by weight: 90% by weight), (5% by weight: 95% by weight) and (1% by weight: 99% by weight). Values of maximum temperature, optical anisotropy, viscosity and dielectric anisotropy with regard to the compound were determined according to the extrapolation method.

A base liquid crystal described below was used. A proportion of the component compound was expressed in terms of % by weight .

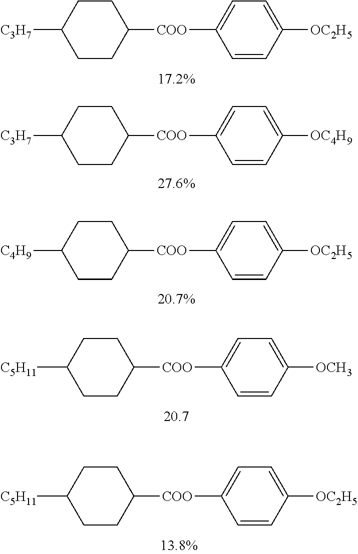

Measuring method: Characteristics were measured according to the methods described below. Most of the methods are described in the Standard of Japan Electronics and Information Technology Industries Association (hereinafter, abbreviated as JEITA) discussed and established in JEITA (JEITA ED-2521B). A modification of the methods was also used. No thin film transistor (TFT) was attached to a TN device used for measurement.

(1) Maximum temperature of a nematic phase (NI; ° C.) : A sample was placed on a hot plate in a melting point apparatus equipped with a polarizing microscope, and heated at a rate of 1° C. per minute. Temperature when part of the sample began to change from a nematic phase to an isotropic liquid was measured. A higher limit of the temperature range of the nematic phase may be occasionally abbreviated as “maximum temperature.”

(2) Minimum temperature of a nematic phase (T_{c}; ° C.): Samples each having a nematic phase were put in glass vials and kept in freezers at temperatures of 0° C., −10° C., −20° C., −30° C. and −40° C. for 10 days, and then liquid crystal phases were observed. For example, when the sample was maintained in the nematic phase at —20° C. and changed to crystals or a smectic phase at −30° C., Tc of the sample was expressed as Tc<−20° C. A lower limit of the temperature range of the nematic phase may be occasionally abbreviated as “minimum temperature.”

(3) Viscosity (bulk viscosity; η; measured at 20° C.; mPa·s): For measurement, an E type rotational viscometer by Tokyo Keiki Co., Ltd. was used.

(4) Viscosity (rotational viscosity; γ1; measured at 25° C.; mPa·s): Measurement was carried out according to the method described in M. Imai et al., Molecular Crystals and Liquid Crystals, Vol. 259, p. 37 (1995). A sample was put in a TN device in which a distance (cell gap) between two glass substrates was 20 micrometers. Voltage was applied stepwise to the device in the range of 39 V to 50 V at an increment of 1 V. After a period of 0.2 second with no voltage application, voltage was repeatedly applied under conditions of only one rectangular wave (rectangular pulse; 0.2 second) and no voltage application (2 seconds). A peak current and a peak time of a transient current generated by the applied voltage were measured. A value of rotational viscosity was obtained from the measured values according to calculating equation (8) on page 40 of the paper presented by M. Imai et al. Dielectric anisotropy required for the calculation was measured by a method described in section (6) described below.

(5) Optical anisotropy (refractive index anisotropy; Δn; measured at 25° C.) : Measurement was carried out by an Abbe refractometer with a polarizing plate mounted on an ocular, using light at a wavelength of 589 nanometers. A surface of a main prism was rubbed in one direction, and then a sample was added dropwise onto the main prism. A refractive index (n)was measured when the direction of polarized light was parallel to the direction of rubbing. A refractive index (n1) was measured when the direction of polarized light was perpendicular to the direction of rubbing. A value of the optical anisotropy (4n) was calculated from an equation: Δn=n∥−n⊥.

(6) Dielectric anisotropy (Δε; measured at 25° C.): A value of the dielectric anisotropy was calculated from an equation: Δε=ε∥−ε⊥. A dielectric constant (ε∥ and ε⊥) was measured as described below.
1) Measurement of a dielectric constant (ε∥): An ethanol (20 mL) solution of octadecyltriethoxysilane (0.16 mL) was applied to a well-cleaned glass substrate. After rotating the glass substrate with a spinner, the glass substrate was heated at 150° C. for 1 hour. A sample was put in a VA device in which a distance (cell gap) between two glass substrates was 4 micrometers, and the device was sealed with an ultraviolet-curable adhesive. Sine waves (0.5 V, 1 kHz) were applied to the device, and after 2 seconds, a dielectric constant (ε∥) in a major axis direction of the liquid crystal molecules was measured.
2) Measurement of a dielectric constant (ε⊥) : A polyimide solution was applied to a well-cleaned glass substrate. After calcining the glass substrate, rubbing treatment was applied to the alignment film obtained. A sample was put in a TN device in which a distance (cell gap) between two glass substrates was 9 micrometers and a twist angle was 80 degrees. Sine waves (0.5 V, 1 kHz) were applied to the device, and after 2 seconds, a dielectric constant (ε⊥) in the minor axis direction of the liquid crystal molecules was measured.

(7) Threshold voltage (Vth; measured at 25° C.; V) : An LCD-5100 luminance meter made by Otsuka Electronics Co., Ltd. was used for measurement. A light source was a halogen lamp. A sample was put in a normally black mode VA device in which a distance (cell gap) between two glass substrates was 4 micrometers and a rubbing direction was anti-parallel, and the device was sealed with an ultraviolet-curable adhesive. A voltage (60 Hz, rectangular waves) to be applied to the device was stepwise increased from 0 V to 20 V at an increment of 0.02 V. On the occasion, the device was irradiated with light from a direction perpendicular to the device, and an amount of light transmitted through the device was measured. A voltage-transmittance curve was prepared, in which a maximum amount of light corresponds to 100% transmittance and a minimum amount of light corresponds to 0% transmittance. A threshold voltage is expressed in terms of a voltage at 10% transmittance.

(8) Voltage holding ratio (VHR-1; measured at 25° C.; %) : A TN device used for measurement had a polyimide alignment film, and a distance (cell gap) between two glass substrates was 5 micrometers. A sample was put in the device, and the device was sealed with an ultraviolet-curable adhesive. A pulse voltage (60 microseconds at 5 V) was applied to the TN device and the device was charged. A decaying voltage was measured for 16.7 milliseconds with a high-speed voltmeter, and area A between a voltage curve and a horizontal axis in a unit cycle was determined. Area B is an area without decay. A voltage holding ratio is expressed in terms of a percentage of area A to area B.

(9) Voltage holding ratio (VHR-2; measured at 80° C.; %): A voltage holding ratio was measured according to a procedure identical to the procedure described above except that measurement was carried out at 80° C. in place of 25° C. The value thus obtained was expressed in terms of VHR-2.

(10) Voltage holding ratio (VHR-3; measured at 25° C.); : Stability to ultraviolet light was evaluated by measuring a voltage holding ratio after a device was irradiated with ultraviolet light. A TN device used for measurement had a polyimide alignment film and a cell gap was 5 micrometers. A sample was injected into the device, and then the device was irradiated with light for 20 minutes. Alight source was an ultra high-pressure mercury lamp USH-500D (made by Ushio, Inc.), and a distance between the device and the light source was 20 centimeters. In measurement of VHR-3, a decaying voltage was measured for 16.7 milliseconds. A composition having large VHR-3 has a large stability to ultraviolet light. A value of VHR-3 is preferably 90% or more, and further preferably 95% or more.

(11) Voltage holding ratio (VHR-4; measured at 25° C.; %): Stability to heat was evaluated by measuring a voltage holding ratio after a TN device into which a sample was injected was heated in a constant-temperature bath at 80° C. for 500 hours. In measurement of VHR-4, a decaying voltage was measured for 16.7 milliseconds. A composition having large VHR-4 has a large stability to heat.

(12) Response time (τ; measured at 25° C.; ms) : For measurement, an LCD-5100 luminance meter made by Otsuka Electronics Co., Ltd. was used. A light source was a halogen lamp. A low-pass filter was set to 5 kHz. A sample was put in a normally black mode VA device in which a distance (cell gap) between two glass substrates was 4 micrometers and a rubbing direction was anti-parallel. The device was sealed with an ultraviolet-curable adhesive. A voltage (rectangular waves; 60 Hz, 10 V, 0.5 second) was applied to the device. On the occasion, the device was irradiated with light from a direction perpendicular to the device, and an amount of light transmitted through the device was measured. The maximum amount of light corresponds to 100% transmittance, and the minimum amount of light corresponds to 0% transmittance. A response time was expressed in terms of time required for a change from 90% transmittance to 10% transmittance (fall time; millisecond).

(13) Specific resistance (ρ; measured at 25° C.; Ωcm) : Into a vessel equipped with electrodes, 1.0 milliliter of a sample was injected. A direct current voltage (10 V) was applied to the vessel, and a direct current after 10 seconds was measured. Specific resistance was calculated from the following equation: (specific resistance)={(voltage)×(electric capacity of a vessel)}/{(direct current)×(dielectric constant of vacuum)).

Compound (1) was prepared according to a method described below.

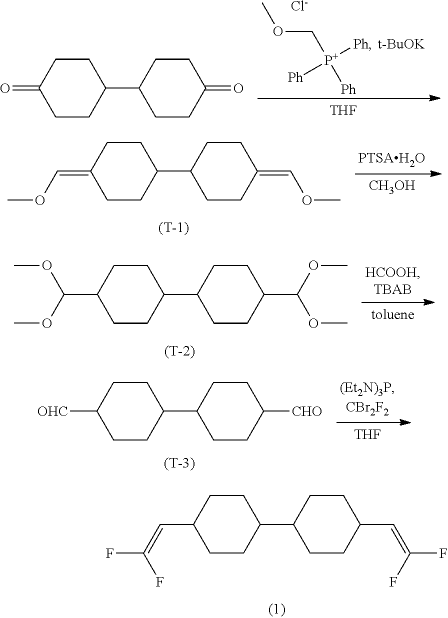

### First Step:

Under a nitrogen atmosphere, (methoxymethyl)triphenylphosphonium chloride (635.0 g, 1853.0 mmol) and THF (tetrahydrofuran) (2000 mL) were put into a reaction vessel, and the resulting mixture was cooled to −30° C. Potassium tert-butoxide (225.0 g, 2008.0 mmol) was added thereto, and the resulting mixture was stirred for 1 hour while maintaining temperature at −30° C. Then, a THF (500 mL) solution of 4,4′-bicyclohexanone (150.0 g, 772.0 mmol) was slowly added dropwise thereto, and after the dropping, the temperature was increased to room temperature, and the resulting mixture was stirred for 15 hours. The resulting reaction mixture was poured into water, and the resulting aqueous layer was subjected to extraction with toluene. Then, organic layers combined were washed with water, and dried over anhydrous magnesium sulfate. The resulting solution was concentrated under reduced pressure, and the residue was purified by silica gel chromatography (heptane:toluene=2:1 in a volume ratio) to obtain compound (T-1) (189.8 g; yield 98.00.

### Second Step:

Under a nitrogen atmosphere, compound (T-1) (189.8 g, 758.0 mmol), p-toluenesulfonic acid monohydrate (87.00 g, 455.0 mmol) and methanol (1500 mL) were put into a reaction vessel, and the resulting mixture was stirred under reflux for 22 hours. The resulting reaction mixture was subjected to extraction with toluene, and the extract was washed with water, a saturated aqueous solution of sodium hydrogencarbonate and water in the above order, and dried over anhydrous magnesium sulfate. The resulting solution was concentrated under reduced pressure, and the residue was purified by recrystallization from a mixed solvent of methanol:heptane=7:1 in a volume ratio to obtain compound (T-2) (165.7 g, yield 69.5%).

### Third Step:

Compound (T-2) (165.7 g, 527.0 mmol), formic acid (330 mL), tetrabutylammonium bromide (34.00 g, 105.0 mmol) and toluene (1000 mL) were put into a reaction vessel, and the resulting mixture was stirred for 2 hours at room temperature. Organic layers were separated, and the organic layers were washed with water, a saturated aqueous solution of sodium hydrogencarbonate and water in the above order, and dried over anhydrous magnesium sulfate. The resulting solution was concentrated under reduced pressure, and the residue was purified by silica gel chromatography (toluene:ethyl acetate=9:1 in a volume ratio) to obtain compound (T-3) (143.8 g; yield 94.0%).

### Fourth Step:

Under a nitrogen atmosphere, dibromodifluoromethane (51.38 g, 244.9 mmol) and THF (90 mL) were put into a reaction vessel, and the resulting mixture was cooled to 0° C. A THF (230 mL) solution of tris (diethylamino) phosphine (121.1g, 489.7 mmol) was slowly added dropwise thereto, and after the dripping, the resulting mixture was stirred for 1 hour while maintaining temperature at 0° C. Then, a THF (90 mL) solution of compound (T-3) (24.75 g, 111.3 mmol) was slowly added dropwise thereto, and after the dropping, the temperature was increased to room temperature, and the resulting mixture was stirred for 12 hours at room temperature. The resulting reaction mixture was poured into water, and the resulting aqueous layer was subjected to extraction with heptane. Organic layers combined were washed with a 1N-hydrochloric acid aqueous solution and water in the above order, and dried over anhydrous magnesium sulfate. The resulting solution was concentrated under reduced pressure, and the residue was purified by silica gel chromatography (heptane). The purified residue was further purified by recrystallization from heptane to obtain compound (1) (14.18 g, yield 43.90).

¹H-NMR (ppm; CDCl₃): δ3.99 (ddd, J=26.0 Hz, J =9.45 Hz, J=3.15 Hz, 2H), 2.09-2.02 (m, 2H), 1.77-1.72 (m, 8H), 1.11-0.99 (m, 10H).

Compounds in Examples were expressed using symbols according to definitions described in Table 3 below. In Table 3, a configuration of 1,4-cyclohexylene is trans. A parenthesized number next to a symbolized compound corresponds to the number of the compound. A symbol (−) means any other liquid crystal compound. A ratio (percentage) of the liquid crystal compound is expressed in terms of weight percent (%) by weight) based on the weight of the liquid crystal composition. Values of the characteristics of the composition were summarized in a last part.

TABLE 3
Method for Description of Compounds using Symbols
R—(A₁)—Z₁— . . . —Zₙ—(Aₙ)—R′

| 1) Left-terminal Group R— | Symbol |
|---|---|
| F—CₙH₂ₙ— | Fn- |
| CₙH₂ₙ₊₁— | n- |
| CₙH₂ₙ₊₁O— | nO— |
| CₘH₂ₘ₊₁OCₙH₂ₙ— | mOn- |
| CH₂═CH— | V— |
| CₙH₂ₙ₊₁—CH═CH— | nV— |
| CH₂═CH—CₙH₂ₙ— | Vn- |
| CₘH₂ₘ₊₁—CH═CH—CₙH₂ₙ— | mVn- |
| CF₂═CH— | VFF— |
| CF₂═CH—CₙH₂ₙ— | VFFn- |
| CH₂═CH—COO— | AC— |
| CH₂═C(CH₃)—COO— | MAC— |
| 2) Right-terminal Group —R′ | Symbol |
| —CₙH₂ₙ₊₁ | -n |
| —OCₙH₂ₙ₊₁ | —On |
| —CH═CH₂ | —V |
| —CH═CH—CₙH₂ₙ₊₁ | —Vn |
| —CₙH₂ₙ—CH═CH₂ | -nV |
| —CₘH₂ₘ—CH═CH—CₙH₂ₙ₊₁ | -mVn |
| —CH═CF₂ | —VFF |
| —OCO—CH═CH₂ | —AC |
| —OCO—C(CH₃)═CH₂ | —MAC |
| 3) Bonding Group —Zₙ— | Symbol |
| —CₙH₂ₙ— | n |
| —COO— | E |
| —CH═CH— | V |
| —CH═CHO— | VO |
| —OCH═CH— | OV |
| —CH₂O— | 1O |
| —OCH₂— | O1 |
| 4) Ring Structure —Aₙ— | Symbol |
| 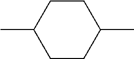 | H |
| 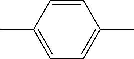 | B |
| 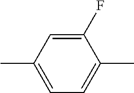 | B(F) |
| 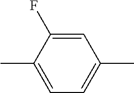 | B(2F) |
| 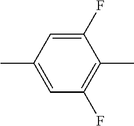 | B(F,F) |
| 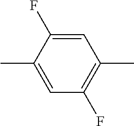 | B(2F,5F) |
| 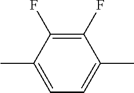 | B(2F,3F) |
| 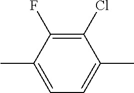 | B(2F,3CL) |
| 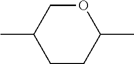 | dh |
| 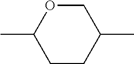 | Dh |
| 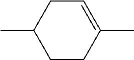 | ch |
| 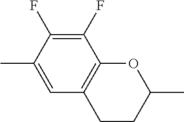 | Cro(7F,8F) |

5) Examples of Description
Example 1 VFF—HH—VFF

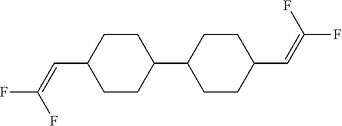 [SMILES: FC(F)=CC1CCC(C2CCC(C=C(F)F)CC2)CC1]

Example 2 2-BB(F)B-3

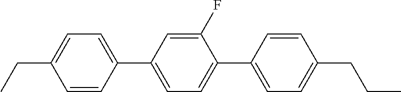 [SMILES: CCCc1ccc(-c2ccc(-c3ccc(CC)cc3)cc2F)cc1]

Example 3 V—HHB-1

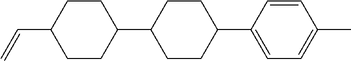 [SMILES: C=CC1CCC(C2CCC(c3ccc(C)cc3)CC2)CC1]

Example 4 3-HHB(2F,3F)—O2

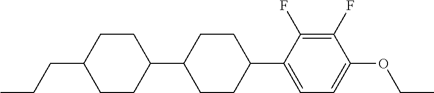 [SMILES: CCCC1CCC(C2CCC(c3ccc(OCC)c(F)c3F)CC2)CC1]

### Example 1

| | | |
|---|---|---|
| VFF-HH-VFF | (1) | 10% |
| 3-HB(2F,3F)-O2 | (2-1) | 5% |
| 5-HB(2F,3F)-O2 | (2-1) | 3% |
| 5-H2B(2F,3F)-O2 | (2-2) | 9% |
| 3-HHB(2F,3F)-O2 | (2-6) | 8% |
| 2-HH1OB(2F,3F)-O2 | (2-8) | 4% |
| 2-BB(2F,3F)B-3 | (2-9) | 3% |
| 5-HBB(2F,3F)-O2 | (2-10) | 6% |
| V-HBB(2F,3F)-O4 | (2-10) | 4% |
| 3-HHB(2F,3Cl)-O2 | (2-12) | 2% |
| 5-HHB(2F,3Cl)-O2 | (2-12) | 3% |
| 3-HBB(2F,3Cl)-O2 | (2-13) | 2% |
| 5-HBB(2F,3Cl)-O2 | (2-13) | 3% |
| 3-HH1OCro(7F,8F)-5 | (2-15) | 4% |
| 3-DhB(2F,3F)-O2 | (2) | 3% |
| 3-HH-V | (3-1) | 15% |
| 3-HH-V1 | (3-1) | 9% |
| V-HBB-2 | (3-6) | 2% |
| 1-BB(F)B-2V | (3-7) | 2% |
| 5-B(F)BB-2 | (3-8) | 3% |

NI=82.6° C.; η=18.2 mPa·s; Δn=0.109; Δε=−3.2.

### Comparative Example 1

The composition in Example 1 contains compound (1) being a first component. For comparison, a composition in which a compound being a first component in Example 1 was replaced by a similar compound was taken as Comparative Example 1.

| | | |
|---|---|---|
| 3-HB(2F,3F)-O2 | (2-1) | 5% |
| 5-HB(2F,3F)-O2 | (2-1) | 3% |
| 5-H2B(2F,3F)-O2 | (2-2) | 9% |
| 3-HHB(2F,3F)-O2 | (2-6) | 8% |
| 2-HH1OB(2F,3F)-O2 | (2-8) | 4% |
| 2-BB(2F,3F)B-3 | (2-9) | 3% |
| 5-HBB(2F,3F)-O2 | (2-10) | 6% |
| V-HBB(2F,3F)-O4 | (2-10) | 4% |
| 3-HHB(2F,3Cl)-O2 | (2-12) | 2% |
| 5-HHB(2F,3Cl)-O2 | (2-12) | 3% |
| 3-HBB(2F,3Cl)-O2 | (2-13) | 2% |
| 5-HBB(2F,3Cl)-O2 | (2-13) | 3% |
| 3-HH1OCro(7F,8F)-5 | (2-15) | 4% |
| 3-DhB(2F,3F)-O2 | (2) | 3% |
| 3-HH-V | (3-1) | 15% |
| 3-HH-V1 | (3-1) | 9% |
| V-HBB-2 | (3-6) | 2% |
| 1-BB(F)B-2V | (3-7) | 2% |
| 5-B(F)BB-2 | (3-8) | 3% |
| 5-HH-VFF | (—) | 10% |

NI =85.1° C.; Tc<−20° C.; η=20.0 mPa·s; Δn=0.109; Δε=−3.1.

### Example 2

| | | |
|---|---|---|
| VFF-HH-VFF | (1) | 5% |
| 2-H1OB(2F,3F)-O2 | (2-3) | 8% |
| 3-H1OB(2F,3F)-O2 | (2-3) | 8% |
| 3-HH1OB(2F,3F)-O2 | (2-8) | 11% |
| 2-HBB(2F,3F)-O2 | (2-10) | 3% |
| 3-HBB(2F,3F)-O2 | (2-10) | 8% |
| V-HBB(2F,3F)-O2 | (2-10) | 8% |
| V-HBB(2F,3F)-O4 | (2-10) | 5% |
| 2-HH-3 | (3-1) | 18% |
| 3-HB-O2 | (3-2) | 15% |
| 1-BB-3 | (3-3) | 2% |
| 3-HBB-2 | (3-6) | 9% |

NI =72.7° C.; Tc<−20° C.; η=17.5 mPa·s; Δn=0.102; Δε=−3.3.

### Example 3

| | | |
|---|---|---|
| VFF-HH-VFF | (1) | 5% |
| V-HB(2F,3F)-O2 | (2-1) | 5% |
| 2-BB(2F,3F)-O2 | (2-4) | 5% |
| 3-BB(2F,3F)-O2 | (2-4) | 6% |
| V2-BB(2F,3F)-O2 | (2-4) | 6% |
| V-HHB(2F,3F)-O1 | (2-6) | 3% |
| V-HHB(2F,3F)-O2 | (2-6) | 8% |
| V-HHB(2F,3F)-O4 | (2-6) | 9% |
| V2-HHB(2F,3F)-O2 | (2-6) | 6% |
| V-HBB(2F,3F)-O2 | (2-10) | 6% |
| V-HBB(2F,3F)-O4 | (2-10) | 6% |
| 3-HH-V | (3-1) | 28% |
| V-HHB-1 | (3-5) | 7% |

NI=75.9° C.; Tc<−20° C.; η=12.8 mPa·s; Δn=0.102; Δε=−3.4.

### Example 4

| | | |
|---|---|---|
| VFF-HH-VFF | (1) | 8% |
| V-HB(2F,3F)-O2 | (2-1) | 5% |
| 2-BB(2F,3F)-O2 | (2-4) | 5% |
| 5-BB(2F,3F)-O2 | (2-4) | 6% |
| V2-BB(2F,3F)-O2 | (2-4) | 6% |
| 2-HHB(2F,3F)-O2 | (2-6) | 3% |
| 3-HHB(2F,3F)-O2 | (2-6) | 8% |
| 5-HHB(2F,3F)-O2 | (2-6) | 9% |
| V2-HHB(2F,3F)-O2 | (2-6) | 6% |
| 4-HBB(2F,3F)-O2 | (2-10) | 6% |
| 5-HBB(2F,3F)-O2 | (2-10) | 6% |
| 4-HH-V | (3-1) | 8% |
| 5-HH-V | (3-1) | 5% |
| 3-HH-4 | (3-1) | 4% |
| 3-HH-5 | (3-1) | 4% |
| 2-HH-5 | (3-1) | 4% |
| 3-HHB-1 | (3-5) | 4% |
| 3-HHB-O1 | (3-5) | 3% |

NI=87.0° C.; Tc<−20° C.; η=17.8 mPa·s; Δn=0.100; Δε=−3.2.

### Example 5

| | | |
|---|---|---|
| VFF-HH-VFF | (1) | 10% |
| 3-H2B(2F,3F)-O2 | (2-2) | 3% |
| 2-BB(2F,3F)-O2 | (2-4) | 9.5% |
| V2-BB(2F,3F)-O2 | (2-4) | 10% |
| 3-HH2B(2F,3F)-O2 | (2-7) | 9.5% |
| 3-HDhB(2F,3F)-O2 | (2-16) | 14% |
| 3-dhBB(2F,3F)-O2 | (2-17) | 8% |
| 3-HH-V | (3-1) | 22% |
| V-HHB-1 | (3-5) | 12% |
| V2-HHB-1 | (3-5) | 2% |

NI=74.0° C.; Tc<−20° C.; η=14.0 mPa·s; Δn=0.101; Δε=−3.3.

### Example 6

| | | |
|---|---|---|
| VFF-HH-VFF | (1) | 5% |
| 2-H1OB(2F,3F)-O2 | (2-3) | 8% |
| 3-H1OB(2F,3F)-O2 | (2-3) | 8% |
| 3-HH1OB(2F,3F)-O2 | (2-8) | 11% |
| 2-HBB(2F,3F)-O2 | (2-10) | 3% |
| 3-HBB(2F,3F)-O2 | (2-10) | 8% |
| V-HBB(2F,3F)-O2 | (2-10) | 8% |
| V-HBB(2F,3F)-O4 | (2-10) | 5% |
| 3-HH-V | (3-1) | 15% |
| 2-HH-3 | (3-1) | 6% |
| 7-HB-1 | (3-2) | 2% |
| 5-HB-O2 | (3-2) | 6% |
| 1-BB-5 | (3-3) | 3% |
| V2-BB-1 | (3-3) | 2% |
| 3-HHB-3 | (3-5) | 4% |
| 3-HBB-2 | (3-6) | 6% |

NI=74.1° C.; Tc<−20° C.; η=15.4 mPa·s; Δn=0.105; Δε=−3.3.

### Example 7

| | | |
|---|---|---|
| VFF-HH-VFF | (1) | 5% |
| 2-H1OB(2F,3F)-O2 | (2-3) | 8% |
| 3-H1OB(2F,3F)-O2 | (2-3) | 8% |
| 3-HH1OB(2F,3F)-O2 | (2-8) | 11% |
| 2-HBB(2F,3F)-O2 | (2-10) | 3% |
| 3-HBB(2F,3F)-O2 | (2-10) | 8% |
| V-HBB(2F,3F)-O2 | (2-10) | 8% |
| V-HBB(2F,3F)-O4 | (2-10) | 5% |
| 3-HH-V | (3-1) | 7% |
| 2-HH-3 | (3-1) | 18% |
| 3-HB-O2 | (3-2) | 8% |
| 1-BB-3 | (3-3) | 2% |
| 3-HHEH-3 | (3-4) | 3% |
| 3-HBB-2 | (3-6) | 3% |
| 2-BB(F)B-3 | (3-7) | 3% |

NI=72.9° C.; Tc<−20° C.; η=15.7 mPa·s; Δn=0.100; Δε=−3.4.

### Example 8

| | | |
|---|---|---|
| VFF-HH-VFF | (1) | 10% |
| 3-HB(2F,3F)-O2 | (2-1) | 3% |
| 2-BB(2F,3F)-O2 | (2-4) | 10% |
| V2-BB(2F,3F)-O2 | (2-4) | 10% |
| V-HHB(2F,3F)-O2 | (2-6) | 9% |
| 3-HDhB(2F,3F)-O2 | (2-16) | 14% |
| 3-dhBB(2F,3F)-O2 | (2-17) | 8% |
| 3-HH-V | (3-1) | 24% |
| V-HHB-1 | (3-5) | 10% |
| 3-HHEBH-3 | (3-11) | 2% |

NI=71.8° C.; Tc<−20° C.;η=14.7 mPa·s; Δn=0.099; Δε=−3.4.

### Example 9

| | | |
|---|---|---|
| VFF-HH-VFF | (1) | 5% |
| 2-H1OB(2F,3F)-O2 | (2-3) | 8% |
| 3-H1OB(2F,3F)-O2 | (2-3) | 8% |
| 3-HH1OB(2F,3F)-O2 | (2-8) | 11% |
| 2-HBB(2F,3F)-O2 | (2-10) | 3% |
| 3-HBB(2F,3F)-O2 | (2-10) | 8% |
| V-HBB(2F,3F)-O2 | (2-10) | 8% |
| V-HBB(2F,3F)-O4 | (2-10) | 5% |
| 3-HH-V | (3-1) | 27% |
| 3-HH-4 | (3-1) | 7% |
| 1-BB-3 | (3-3) | 4% |
| 3-HBB-2 | (3-6) | 3% |
| 5-HBB(F)B-2 | (3-13) | 3% |

NI=77.2° C.; Tc<−20° C.; η=13.8 mPa·s; Δn=0.102; Δε=−

### Example 10

| | | |
|---|---|---|
| VFF-HH-VFF | (1) | 10% |
| V-HB(2F,3F)-O2 | (2-1) | 5% |
| 2-BB(2F,3F)-O2 | (2-4) | 5% |
| V2-BB(2F,3F)-O2 | (2-4) | 6% |
| 2O-B(2F,3F)B(2F,3F)-O2 | (2-5) | 5% |
| V-HHB(2F,3F)-O1 | (2-6) | 5% |
| V-HHB(2F,3F)-O2 | (2-6) | 10% |
| V2-HHB(2F,3F)-O2 | (2-6) | 6% |
| V-HBB(2F,3F)-O2 | (2-10) | 8% |
| 3-HchB(2F,3F)-O2 | (2-19) | 5% |
| 2-BB(2F)B(2F,3F)-O4 | (2-20) | 2% |
| 3-HH-V | (3-1) | 24% |
| V-HHB-1 | (3-5) | 9% |

NI=81.2° C.; η=13.5 mPa·s; Δn=0.105; Δε=−3.4.

### Example 11

| | | |
|---|---|---|
| VFF-HH-VFF | (1) | 8% |
| 3-HB(2F,3F)-O2 | (2-1) | 17% |
| 2-HH1OB(2F,3F)-O2 | (2-8) | 4% |
| V-HHB(2F,3F)-O1 | (2-6) | 5% |
| V-HHB(2F,3F)-O2 | (2-6) | 8% |
| 3-HBB(2F,3F)-O2 | (2-10) | 7% |
| V-HBB(2F,3F)-O2 | (2-10) | 8% |
| 3-HEB(2F,3F)B(2F,3F)-O2 | (2-11) | 4% |
| 3-chB(2F,3F)-O2 | (2-18) | 3% |
| 3-BB(F)B(2F,3F)-O2 | (2-21) | 3% |
| 3-HH-V | (3-1) | 20% |
| 3-HH-V1 | (3-1) | 6% |
| V-HBB-2 | (3-6) | 2% |
| 3-BB2B-1 | (3-9) | 5% |

NI=75.7° C.; η=16.5 mPa·s; Δn=0.103; Δε=−3.3.

### Example 12

| | | |
|---|---|---|
| VFF-HH-VFF | (1) | 7% |
| 2-H1OB(2F,3F)-O2 | (2-3) | 8% |
| 3-H1OB(2F,3F)-O2 | (2-3) | 5% |
| 2-HH1OB(2F,3F)-O2 | (2-8) | 11% |
| 3-HBB(2F,3F)-O2 | (2-10) | 8% |
| V-HBB(2F,3F)-O2 | (2-10) | 8% |
| V-HBB(2F,3F)-O4 | (2-10) | 8% |
| 3-H1OCro(7F,8F)-5 | (2-14) | 3% |
| 3-HH-V | (3-1) | 27% |
| 3-HH-4 | (3-1) | 5% |
| 1-BB-3 | (3-3) | 4% |
| 3-HBB-2 | (3-6) | 3% |
| 5-HB(F)HH-2 | (3-10) | 3% |

NI=75.1° C.; η=15.0 mPa·s; Δn=0.102; Δε=−3.4.

### Example 13

| | | |
|---|---|---|
| VFF-HH-VFF | (1) | 10% |
| V-HB(2F,3F)-O4 | (2-1) | 8% |
| 2-BB(2F,3F)-O2 | (2-4) | 8% |
| V2-BB(2F,3F)-O2 | (2-4) | 9% |
| 3-HHB(2F,3F)-O2 | (2-6) | 8% |
| V-HHB(2F,3F)-O2 | (2-6) | 9% |
| V2-HHB(2F,3F)-O2 | (2-6) | 6% |
| 3-HBB(2F,3F)-O2 | (2-10) | 3% |
| V-HBB(2F,3F)-O2 | (2-10) | 6% |
| 2O-B(2F)B(2F,3F)-O2 | (2-22) | 3% |
| 3-HH-V | (3-1) | 25% |
| 3-HHB-1 | (3-5) | 2% |
| 3-HB(F)BH-5 | (3-12) | 3% |

NI=71.1° C.; η=13.1 mPa·s; Δn=0.102; Δε=−3.5.

The viscosity (n) of the composition in Comparative Example 1 was 20.0 mPa·s. Meanwhile, the q of the composition in Example 1 was 18.2 mPa·s. Thus, the composition in Example 1 had small viscosity in comparison with the composition in Comparative Example. Accordingly, the liquid crystal composition of the invention is concluded to have superb characteristics.

### INDUSTRIAL APPLICABILITY

A liquid crystal composition according to the invention can be used for a liquid crystal monitor, a liquid crystal television and so forth.

What is claimed is:

1. A liquid crystal composition containing at least one compound selected from the group of compounds represented by formula (1) as a first component, and having a nematic phase and negative dielectric anisotropy: 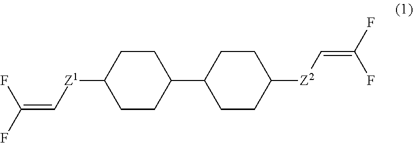
wherein, in formula (1), Z¹ and Z² are independently a single bond or alkylene having 1 to 10 carbons, and in the alkylene, at least one piece of —CH₂— may be replaced by —O—, —CO—, —COO— or —OCO—.

2. The liquid crystal composition according to claim 1, wherein a composition of the first component is in the range of 3% by weight to 50% by weight.

3. The liquid crystal composition according to claim 1, containing at least one compound selected from the group of compounds represented by formula (2) as a second component: 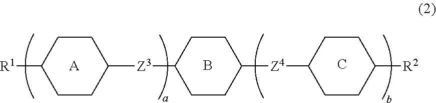
wherein, in formula (2), R¹ and R² are independently alkyl having 1 to 12 carbons, alkoxy having 1 to 12 carbons, alkenyl having 2 to 12 carbons, or alkyl having 1 to 12 carbons in which at least one hydrogen is replaced by fluorine or chlorine; ring A and ring C are independently 1,4-cyclohexylene, 1,4-cyclohexenylene, tetrahydropyran-2,5-diyl, 1,4-phenylene, 1,4-phenylene in which at least one hydrogen is replaced by fluorine or chlorine, chroman-2,6-diyl, or chroman-2,6-diyl in which at least one hydrogen is replaced by fluorine or chlorine; ring B is 2,3-difluoro-1,4-phenylene, 2-chloro-3-fluoro-1,4-phenylene, 2,3-difluoro-5-methyl-1,4-phenylene, 3,4,5-trifluoronaphthalene-2,6-diyl or 7,8-difluorochroman-2,6-diyl; Z³ and Z⁴ are independently a single bond, ethylene, carbonyloxy or methyleneoxy; a is 1, 2 or 3; b is 0 or 1; and a sum of a and b is 3 or less.

4. The liquid crystal composition according to claim 3, containing at least one compound selected from the group of compounds represented by formula (2-1) to formula (2-22) as the second component: 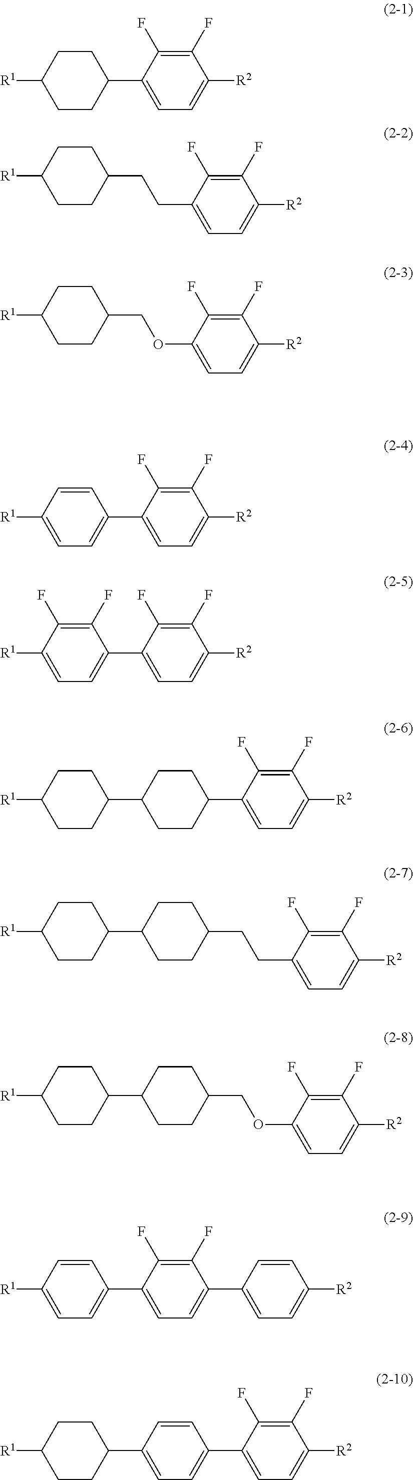 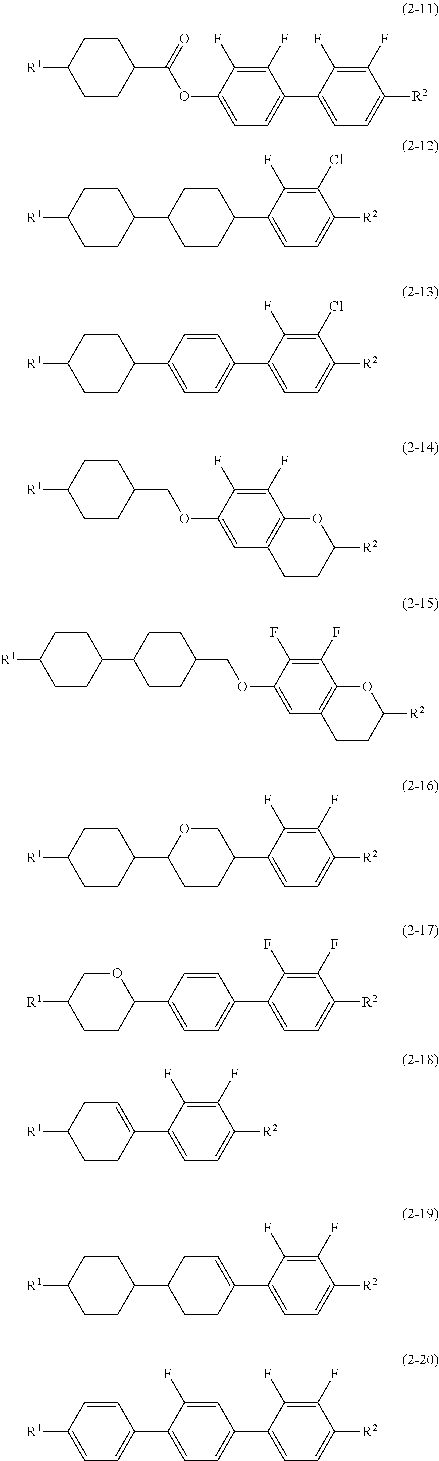 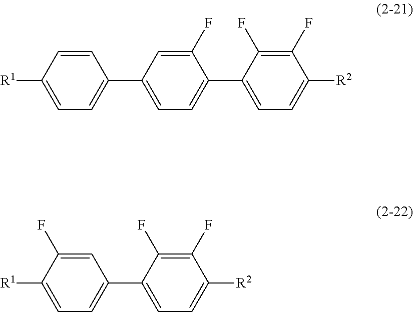
wherein, in formula (2-1) to formula (2-22), R¹ and R² are independently alkyl having 1 to 12 carbons, alkoxy having 1 to 12 carbons, alkenyl having 2 to 12 carbons, or alkyl having 1 to 12 carbons in which at least one hydrogen is replaced by fluorine or chlorine.

5. The liquid crystal composition according to claim 3, wherein a proportion of the second component is in the range of 15% by weight to 70% by weight.

6. The liquid crystal composition according to claim 1, containing at least one compound selected from the group of compounds represented by formula (3) as a third component: 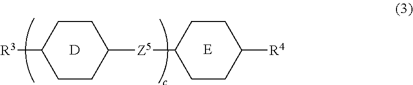
wherein, in formula (3), R³ and R⁴ are independently alkyl having 1 to 12 carbons, alkoxy having 1 to 12 carbons, alkenyl having 2 to 12 carbons, or alkyl having 1 to 12 carbons in which at least one hydrogen is replaced by fluorine or chlorine; ring D and ring E are independently 1,4-cyclohexylene, 1,4-phenylene, 2-fluoro-1,4-phenylene or 2,5-difluoro-1,4-phenylene; Z⁵ is a single bond, ethylene or carbonyloxy; and c is 1, 2 or 3.

7. The liquid crystal composition according to claim 6, containing at least one compound selected from the group of compounds represented by formula (3-1) to formula (3-13) as the third component: 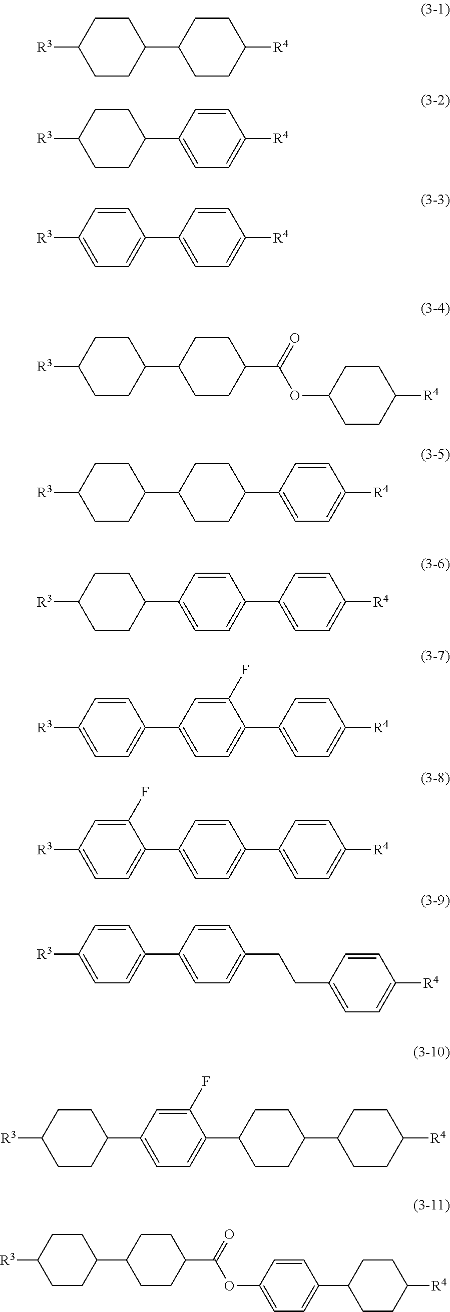 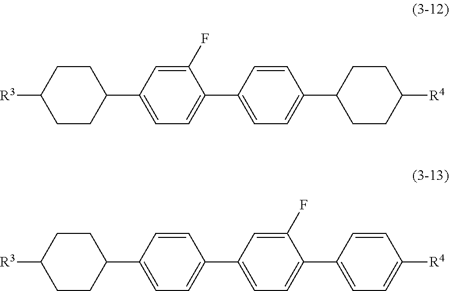
wherein, in formula (3-1) to formula (3-13), R³ and R⁴ are independently alkyl having 1 to 12 carbons, alkoxy having 1 to 12 carbons, alkenyl having 2 to 12 carbons, or alkyl having 1 to 12 carbons in which at least one hydrogen is replaced by fluorine or chlorine.

8. The liquid crystal composition according to claim 6, wherein a proportion of the third component is in the range of 10% by weight to 80% by weight.

9. The liquid crystal composition according to claim 1, containing at least one compound selected from the group of compounds represented by formula (4) as an additive: 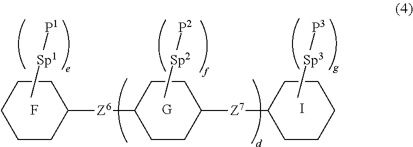
wherein, in formula (4), ring F and ring I are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen is replaced by fluorine or chlorine;
ring G is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen may be replaced by fluorine or chlorine; Z⁶ and Z⁷ are independently a single bond or alkylene having 1 to 10 carbons, and in the alkylene, at least one piece of —CH₂— may be replaced by —O—, —CO—, —COO—, or —OCO—, and at least one piece of —CH₂—CH₂— may be replaced by —CH═CH—, —C(CH₃)═CH—, —CH═C(CH₃)— or —C(CH₃)═C(CH₃)—, and in the groups, at least one hydrogen may be replaced by fluorine or chlorine; P¹, P² and P³ are independently a polymerizable group;
Sp¹, Sp² and Sp³ are independently a single bond or alkylene having 1 to 10 carbons, and in the alkylene, at least one piece of —CH₂— may be replaced by —O—, —COO—, —OCO— or —OCOO—, and at least one piece of —CH₂—CH₂— may be replaced by —CH═CH— or —C≡C—, and in the groups, at least one hydrogen may be replaced by fluorine or chlorine; d is 0, 1 or 2; e, f and g are independently 0, 1, 2, 3 or 4; and a sum of e, f and g is 1 or more.

10. The liquid crystal composition according to claim 9, wherein, in formula (4), P¹, P² and P³ are independently a group selected from the group of polymerizable groups represented by formula (P-1) to formula (P-5): 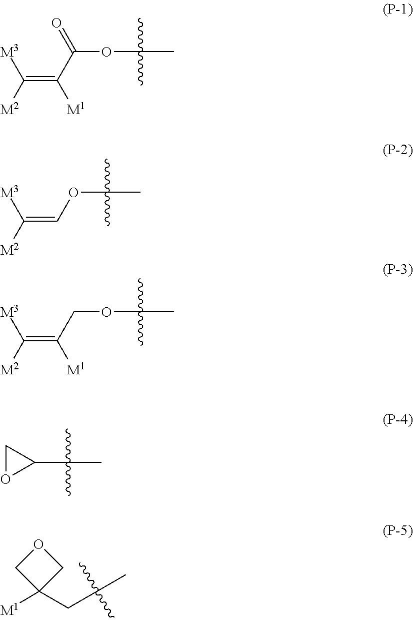
wherein, in formula (P-1) to formula (P-5), M¹, M² and M³ are independently hydrogen, fluorine, alkyl having 1 to 5 carbons, or alkyl having 1 to 5 carbons in which at least one hydrogen is replaced by fluorine or chlorine.

11. The liquid crystal composition according to claim 9, containing at least one compound selected from the group of polymerizable compounds represented by formula (4-1) to formula (4-27) as the additive: 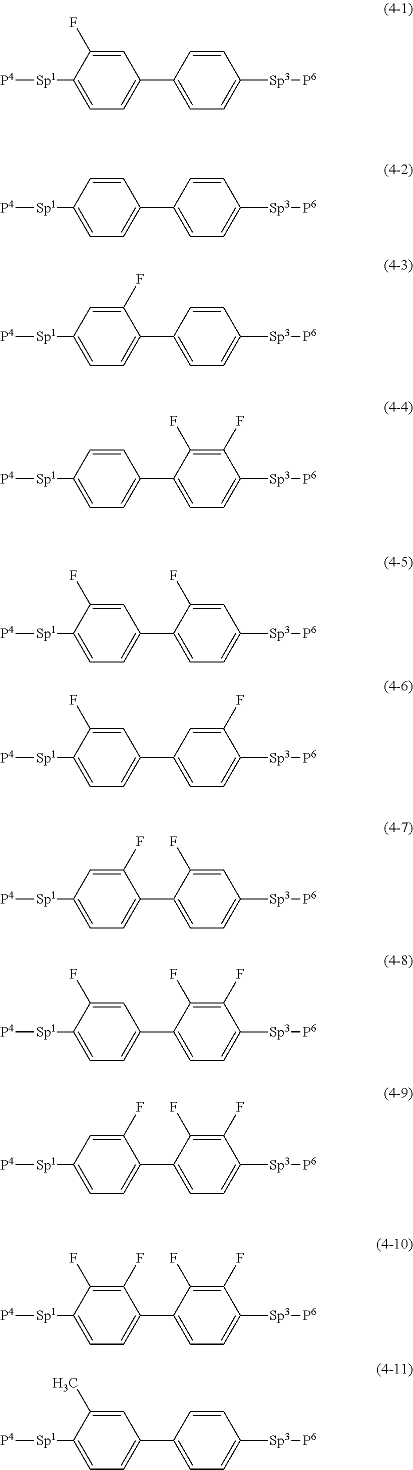 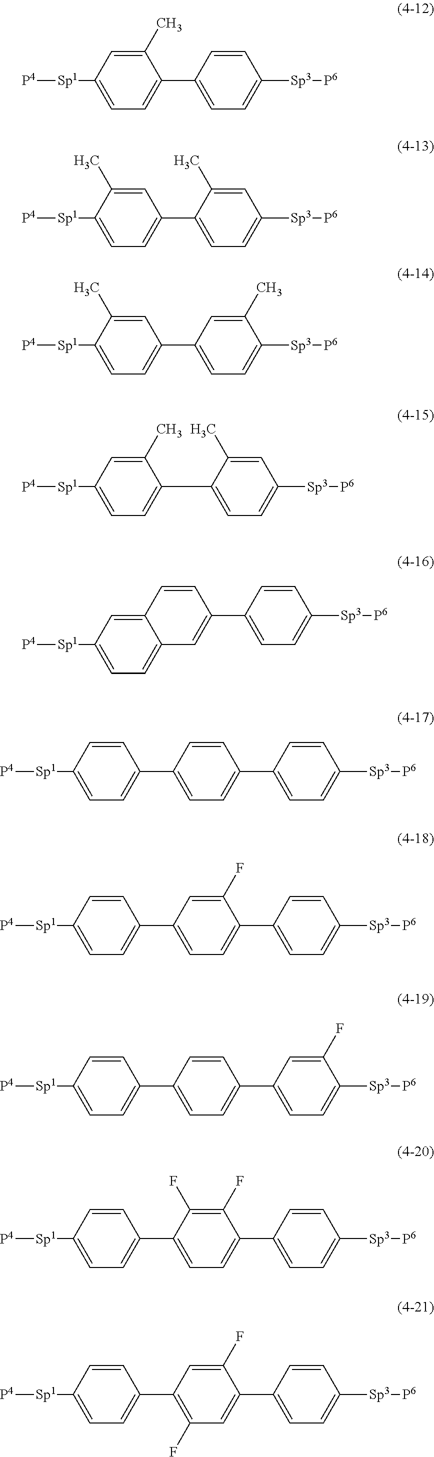 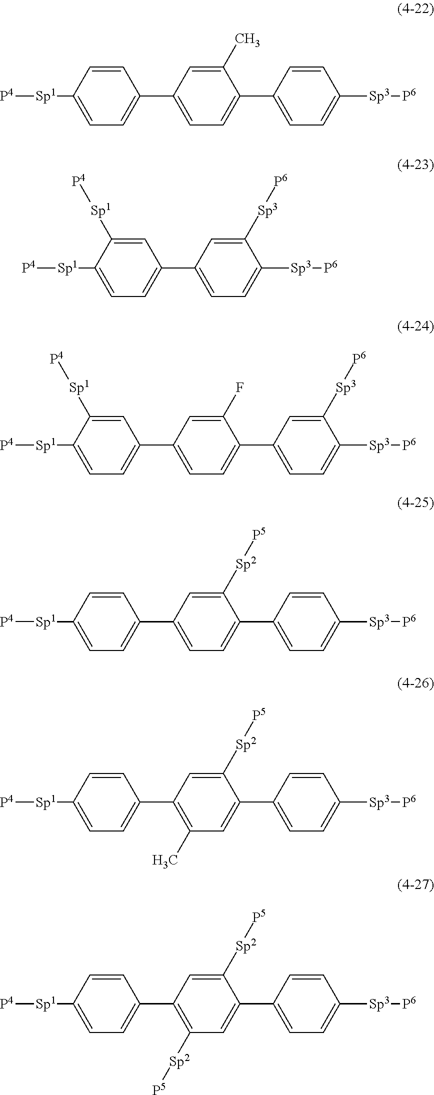
wherein, in formula (4-1) to formula (4-27), P⁴, P⁵ and P⁶ are independently a group selected from the group of polymerizable groups represented by formula (P-1) to formula (P-3) : 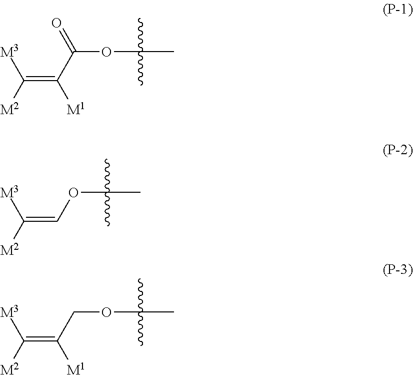
wherein, M³, M² and M³ are independently hydrogen, fluorine, alkyl having 1 to 5 carbons, or alkyl having 1 to 5 carbons in which at least one hydrogen is replaced by fluorine or chlorine; Sp¹, Sp² and Spa are independently a single bond or alkylene having 1 to 10 carbons, and in the alkylene, at least one piece of —CH₂— may be replaced by —O—, —COO—, —OCO— or —OCOO—, and at least one piece of —CH₂—CH₂— may be replaced by —CH═CH— or and in the groups, at least one hydrogen may be replaced by fluorine or chlorine.

12. The liquid crystal composition according to claim 9, wherein a proportion of the additive is in the range of 0.03% by weight to 10% by weight.

13. A liquid crystal display device including the liquid crystal composition according to claim 1.

14. The liquid crystal display device according to claim 13, wherein an operating mode in the liquid crystal display device includes an IPS mode, a VA mode, an FFS mode or an FPA mode, and a driving mode in the liquid crystal display device includes an active matrix mode.

15. A polymer sustained alignment mode liquid crystal display device, wherein the liquid crystal display device includes the liquid crystal composition according to claim 9, and the additive contained in the liquid crystal composition is polymerized.

16. The liquid crystal composition according to claim 3, containing at least one compound selected from the group of compounds represented by formula (3) as a third component: 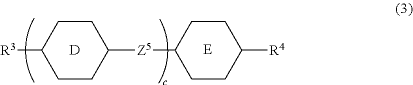
wherein, in formula (3), R³ and R⁴ are independently alkyl having 1 to 12 carbons, alkoxy having 1 to 12 carbons, alkenyl having 2 to 12 carbons, or alkyl having 1 to 12 carbons in which at least one hydrogen is replaced by fluorine or chlorine; ring D and ring E are independently 1,4-cyclohexylene, 1,4-phenylene, 2-fluoro-1,4-phenylene or 2,5-difluoro-1,4-phenylene; Z⁵ is a single bond, ethylene or carbonyloxy; and c is 1, 2 or 3.

17. The liquid crystal composition according to claim 3, containing at least one compound selected from the group of compounds represented by formula (4) as an additive: 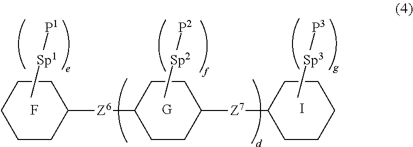
wherein, in formula (4), ring F and ring I are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen is replaced by fluorine or chlorine;
ring G is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen may be replaced by fluorine or chlorine; Z⁶ and Z⁷ are independently a single bond or alkylene having 1 to 10 carbons, and in the alkylene, at least one piece of —CH₂— may be replaced by —O—, —CO—, —COO—, or —OCO—, and at least one piece of —CH₂—CH₂— may be replaced by —CH═CH—, —C(CH₃)═CH—, —CH═C(CH₃)— or —C(CH₃)═C(CH₃)—, and in the groups, at least one hydrogen may be replaced by fluorine or chlorine; P¹, P² and P³ are independently a polymerizable group;
Sp¹, Sp² and Sp³ are independently a single bond or alkylene having 1 to 10 carbons, and in the alkylene, at least one piece of —CH₂— may be replaced by —O—, —COO—, —OCO— or —OCOO—, and at least one piece of —CH₂—CH₂— may be replaced by —CH═CH— or —C≡C—, and in the groups, at least one hydrogen may be replaced by fluorine or chlorine; d is 0, 1 or 2; e, f and g are independently 0, 1, 2, 3 or 4; and a sum of e, f and g is 1 or more.

18. The liquid crystal composition according to claim 6, containing at least one compound selected from the group of compounds represented by formula (4) as an additive: 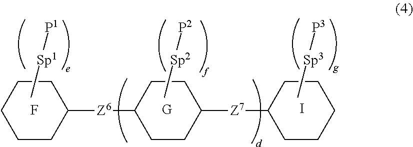
wherein, in formula (4), ring F and ring I are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen is replaced by fluorine or chlorine;
ring G is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen may be replaced by fluorine or chlorine; Z⁶ and Z⁷ are independently a single bond or alkylene having 1 to 10 carbons, and in the alkylene, at least one piece of —CH₂— may be replaced by —O—, —CO—, —COO—, or —OCO—, and at least one piece of —CH₂—CH₂— may be replaced by —CH═CH—, —C(CH₃)═CH—, —CH═C(CH₃)— or —C(CH₃)═C(CH₃)—, and in the groups, at least one hydrogen may be replaced by fluorine or chlorine; P¹, P² and P³ are independently a polymerizable group;
Sp¹, Sp² and Sp³ are independently a single bond or alkylene having 1 to 10 carbons, and in the alkylene, at least one piece of —CH₂— may be replaced by —O—, —COO—, —OCO— or —COO—, and at least one piece of —CH₂—CH₂— may be replaced by —CH═CH— or —C≡C—, and in the groups, at least one hydrogen may be replaced by fluorine or chlorine; d is 0, 1 or 2; e, f and g are independently 0, 1, 2, 3 or 4; and a sum of e, f and g is 1 or more.

19. The liquid crystal composition according to claim 16, containing at least one compound selected from the group of compounds represented by formula (4) as an additive: 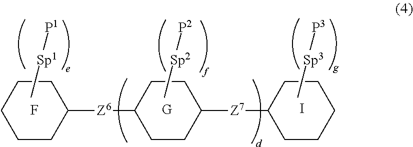
wherein, in formula (4), ring F and ring I are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen is replaced by fluorine or chlorine;
ring G is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in the rings, at least one hydrogen may be replaced by fluorine, chlorine, alkyl having 1 to 12 carbons, alkoxy having 1 to 12 carbons, or alkyl having 1 to 12 carbons in which at least one hydrogen may be replaced by fluorine or chlorine; Z⁶ and Z⁷ are independently a single bond or alkylene having 1 to 10 carbons, and in the alkylene, at least one piece of —CH₂— may be replaced by —O—, —CO—, —COO—, or —OCO—, and at least one piece of —CH₂—CH₂— may be replaced by —CH═CH—, —C(CH₃)═CH—, —CH═C(CH₃)— or —C(CH₃)═C(CH₃)—, and in the groups, at least one hydrogen may be replaced by fluorine or chlorine; P¹, P² and P³ are independently a polymerizable group;
Sp¹, Sp² and Sp³ are independently a single bond or alkylene having 1 to 10 carbons, and in the alkylene, at least one piece of —CH₂— may be replaced by —O—, —COO—, —OCO— or —OCOO—, and at least one piece of —CH₂—CH₂— may be replaced by —CH═CH—or —C≡C—, and in the groups, at least one hydrogen may be replaced by fluorine or chlorine; d is 0, 1 or 2; e, f and g are independently 0, 1, 2, 3 or 4; and a sum of e, f and g is 1 or more.
